(19) United States
(12) Patent Application Publication
(10) Pub. No.: US 2025/0135629 A1
(43) Pub. Date: May 1, 2025

(54) Self-Inventorying Construction Tool Container and Methods of Use Thereof

(71) Applicant: United Rentals, Inc., Stamford, CT (US)

(72) Inventors: Steve Anderson, Stamford, CT (US); Jason Farmer, Stamford, CT (US); Chris Cox, Stamford, CT (US); John Mongan, Stamford, CT (US); Jatin Talreja, Stamford, CT (US); Dali Basor, Stamford, CT (US); Maxi Cordoba, Stamford, CT (US); Mark Haas, Stamford, CT (US)

(21) Appl. No.: 18/925,959

(22) Filed: Oct. 24, 2024

Related U.S. Application Data
(60) Provisional application No. 63/593,408, filed on Oct. 26, 2023.

(51) Int. Cl. B25H 3/02; G06Q 10/087

(52) U.S. Cl. CPC B25H 3/022; G06Q 10/087

(57) ABSTRACT

A self-inventorying tool container for a construction job site includes a tools container structure. The tool container structure includes an enclosure defining an internal tool volume configured to receive a plurality of trackable construction tools, and at least one a door coupled with the enclosure and operable to permit selective access to the internal tool volume and plurality of trackable construction tools held therein. The self-inventorying tool container further includes a plurality of beacons corresponding to the plurality of trackable construction tools, each beacon of the plurality of beacons configured to emit a short-range wireless signal and being removable from the internal volume with the respective trackable tool. The self-inventorying tool container further includes a scanning assembly arranged with the tool container and configured to detect the short-range wireless signal of each respective beacon of the plurality of beacons relative to internal tool volume.

### RELATED APPLICATIONS

The present application relates and claims priority to U.S. Provisional Application No. 63/593,408, filed on Oct. 26, 2023, which is hereby incorporated by reference in its entirety.

### TECHNICAL FIELD

The described examples relate generally to systems, devices, and techniques for managing construction related equipment and tools on a job site.

### BACKGROUND

Construction job sites may employ numerous personnel engaged in the collective and cooperative activity of constructing a project, including constructing and maintaining buildings, facilities, and equipment of all different types. Throughout the project, each personnel may require use of certain hand-held, power, hydraulic or pneumatic tools to complete certain job tasks. Often a common, centrally placed toolbox including such tools is arranged on the job site, and such personnel can take a tool as needed to complete a respective job task. Conventional systems and toolboxes for construction related projects often lack the ability to track the usage and location of such tools on the construction job site. Manual tool audits, pen and paper documentation, and other methods are conventionally used for specific tool vending and management, which can be inefficient and costly. Moreover, conventional techniques often lack the ability to readily produce actionable metrics and other data to facilitate real-time tool inventory management, nor do such techniques provide a sufficient basis for right-sizing tool inventory on subsequent projects, among other deficiencies. As such, there is a need for systems and techniques to facilitate construction equipment and tool management on a job site, such as managing tools on a construction job site having numerous personnel that may need a diverse range of tools at various different times to complete a collective project.

### SUMMARY

In one example, a self-inventorying tool container for a construction job site is disclosed. The self-inventorying tool container includes a tool container structure. The tool container structure includes an enclosure defining an internal tool volume configured to receive a plurality of trackable construction tools. The tool container structure further includes at least one a door coupled with the enclosure and operable to permit selective access to the internal tool volume and plurality of trackable construction tools held therein. The self-inventorying tool container further includes a plurality of beacons corresponding to the plurality of trackable construction tools. Each beacon of the plurality of beacons is configured to emit a short-range wireless signal (such as a Bluetooth signal), and is selectively removable from the internal volume with the respective trackable tool. The self-inventorying tool container further includes a scanning assembly arranged with the tool container and configured to detect the short-range wireless signal of each respective beacon of the plurality of beacons relative to the internal tool volume. The self-inventorying tool container further includes an antenna arranged with the tool container and configured to transmit a container signal indicative of a location of each trackable tool of the plurality of trackable construction tools having a corresponding beacon.

In another example, the scanning assembly may include a Bluetooth gateway and a plurality of Bluetooth Low Energy scanners associated therewith.

In another example, each beacon of the plurality of beacons may include a Bluetooth transmitter.

In another example, the self-inventorying tool container may further include an access management system. The access management system may have a locking mechanism securing the at least one door to the enclosure and being operable to cause a release of the at least one door in response to an unlock signal. The access management system may further include a keypad coupled with an exterior of the enclosure and configured to cause the locking mechanism to receive the unlock signal and release the at least one door in response to a receipt of controlled access code.

In another example, the unlock signal may be associated with a specific worker on the job site based on a value of the controlled access code.

In another example, the self-inventorying tool container may further include a processing unit configured to associate a given beacon and corresponding trackable tool removed from the internal volume with the specific worker.

In another example, the given beacon and corresponding trackable tool may be associated with the specific worker based in part on the scanning assembly detecting the short range wireless signal of the given beacon moving away from the tool container structure when the at least one door is unlocked for the specific user.

In another example, the self-inventorying tool container may further include a door sensor configured to provide a door status signal to the processing unit indicative of the door being in an open or closed configuration.

In another example, the processing unit may be configured to determine a location and an orientation of the tool container structure using one or more of the antenna, an accelerometer, a gyroscope, an altimeter, or a GPS-enable component associated with the tool container structure.

In another example, a construction job site is disclosed. The construction job site includes a self-inventorying tool container, such as any of the self-inventorying tool containers described herein. The construction job site further includes the plurality of trackable construction tools, each trackable tool of the plurality of trackable construction tools has a corresponding beacon of the plurality of beacons.

In another example, a first subset of the plurality of trackable construction tools of the job site is disposed with the internal volume. Further, a second subset of the plurality of trackable construction tools of the job site is disposed across the job site. In this regard, the container signal may be indicative of a location of each trackable tool of the second subset of the plurality of trackable construction tools across the jobsite.

In another example, a third subset of the plurality of trackable construction tools of the job site may be disposed outside of the jobsite. In this regard, the container signal may be indicative of said trackable construction tools of the third subset being missing from the jobsite.

In another example, the self-inventorying tool container may further include a processing unit configured to determine a time period for which any trackable construction tools of the second subset is disposed across the jobsite and outside of the internal tool volume.

In another example, the processing unit may be configured to determine a diagnostic status of the trackable tool on reentry to the internal tool volume.

In another example, the diagnostic status may include a battery life of the trackable tool.

In another example, the processing unit may be configured to analyze a utilization metric for each trackable tool of the plurality of trackable construction tools. The utilization metric may be indicative of a time said trackable tool is disposed outside of the internal tool volume for a given preplanned job task.

In another example, the plurality of trackable construction tools may include power or hydraulic hand-tools, including one or more of a drill, an impact wrench, a saw, or welding equipment.

In another example, a method for inventorying trackable construction tools on a job site is disclosed. The method includes providing a self-inventorying tool container, such as any of the self-inventorying tool containers described herein, to the job site. The self-inventorying tool container includes the plurality of trackable construction tools therein. Each trackable tool of the plurality of trackable construction tools is associated with a corresponding beacon of the plurality of beacons. The method further includes determining, using a processing unit of the self-inventorying tool container, a first location of a first subset of trackable construction tools of the plurality of trackable construction tools based on a short-range wireless signal of each respective beacon being disposed within the internal tool volume. The method further includes determining, the using the processing unit, a second location of a second subset of trackable construction tools of the plurality of trackable construction tools based on a short-range wireless signal of each respective beacon being disposed outside of the internal volume and within the job site. The method further includes transmitting a container signal indicative of the first and second locations to a remote server.

In another example, the method further includes selectively permitting access to the internal volume using an access management system having a locking mechanism configured to release the at least one door form covering the internal tool volume upon a verified code received at keypad of the self-inventorying tool container.

In another example, the method may further include, using the processing unit, developing a report including a utilization metric of the trackable construction tools on the job site, the utilization metric indicative of a time said trackable tool is disposed outside of the internal tool volume for a given preplanned job task.

In another example, the method may further include providing a plurality of the self-inventorying tool containers, such as a plurality of any of the self-inventorying tool containers described herein. The method may further include distributing the plurality of the self-inventorying tool containers across the construction job site.

In another example, the method may further include determining, using a mobile device associated with the plurality of the self-inventorying tool containers, a location of a selected trackable tool among the plurality of the self-inventorying tool containers.

In another example, the method may further include generating one or both of an audio or a visual alert at the self-inventorying tool container of the plurality of the self-inventorying tool containers associated with the selected trackable tool.

In another example, the method may further include generating one or both of an audio or visual alert at one or more self-inventorying tool containers of the plurality of self-inventorying tool containers indicative of an evacuation request for the job site.

In another example, the one or both of the audio or the visual alert may be sequenced to indicate one or both of an evacuation route or a severity of an evacuation event.

In another example, the method may further include generating one or both of an audio or visual alert at one or more self-inventorying tool containers of the plurality of self-inventorying tool containers in response to said self-inventorying tool container remaining open for a predefined period.

In another example, the self-inventorying tool container may further include a light sensor and a light source within the internal tool volume. In this regard, the method may further include operating the light source responsive to a level of light detected in the internal tool volume by the light sensor.

In another example, the self-inventorying tool container may further include a trackable tool charging feature integrated therein. The method may further include wirelessly or hard wired charging one or more trackable tools of the plurality of trackable tools.

In another example, the self-inventorying tool container may further include a power pack, including one or both of a battery storage or solar capture feature. In this regard, the method may further include powering the self-inventorying tool container using the power pack, free from AC or DC connections at the job site.

In another example, the self-inventorying tool container may further include a WiFi or LoRa access point. In this regard, the method may further include providing access to said WiFi or LoRa access point to personnel on the job site to support job site communications.

In another example, the self-inventorying tool container may further include a LoRa environmental sensor. The method may further include sensing environmental conditions using said environmental sensor to support safety of the trackable tools and personnel of the job site.

In another example, the self-inventorying tool container further includes an external power connection capable of support one or more of the following power inputs: 110V AC, 12-28V DC, solar, battery DC. In this regard, the method may further include suppling power to the self-inventorying tool container using the external power connection.

In addition to the example aspects described above, further aspects and examples will become apparent by reference to the drawings and by study of the following description.

### BRIEF DESCRIPTION OF THE DRAWINGS

FIG. 1 depicts an example construction job site including an example self-inventorying tool container.

FIG. 2A depicts the self-inventorying tool container of FIG. 1 in a closed configuration.

FIG. 2B depicts the self-inventorying tool container of FIG. 2A in an open configuration, including certain trackable construction tools.

FIG. 2C depicts the self-inventorying tool container of FIG. 2A in an open configuration, including certain trackable radios.

FIG. 3 depicts a schematic representation of the self-inventorying tool container of FIG. 1.

FIG. 4 depicts an example hardware architecture of the self-inventorying tool container of FIG. 1.

FIG. 5A depicts a schematic top view of the example job site of FIG. 1 including the example self-inventorying tool container.

FIG. 5B depicts a schematic top view of a job site including a plurality of self-inventorying tool containers.

FIG. 6 depicts an example report of trackable construction tools for any of the self-inventorying tool containers described herein.

FIG. 7 depicts another example report of trackable construction tools for any of the self-inventorying tool container described herein.

FIG. 8A depicts a user interface of self-inventorying tool container dashboard.

FIG. 8B depicts a detailed view of a map interface of the user interface of FIG. 8A.

FIG. 8C depicts a user interface of a self-inventorying tool container asset page.

FIG. 8D depicts a user interface of a self-inventorying tool container details page.

FIG. 8E depicts an example window of the user interface of FIG. 8D.

FIG. 8F depicts another example window of the user interface of FIG. 8D.

FIG. 8G depicts a user interface of an alarm notification page.

FIG. 9 depicts a table of example alarms of the user interface of FIG. 8G.

FIG. 10 depicts an example end of day report.

FIG. 11 depicts an example concert job site including an example self-inventorying tool container.

FIG. 12 depicts a flow diagram of an example method for inventorying trackable construction tools on a job site.

FIG. 13 depicts a functional block diagram of a computer-implemented device couplable with any of the self-inventorying tool containers described herein.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

The description that follows includes sample systems, methods, and apparatuses that embody various elements of the present disclosure. However, it should be understood that the described disclosure may be practiced in a variety of forms in addition to those described herein.

The following disclosure relates generally to a self-inventorying tool container and methods of use thereof. The self-inventorying tool container may generally be configured to house a plurality of construction related hand tools, such as certain powered, hydraulic, or pneumatic tools therein, and to track a location of such tools on the job site, both within and outside of the container. As used herein, the term “job site” may refer to a construction site, a concert, and/or other site in which numerous personnel collectively and cooperatively engage in a construction, maintenance, and/or other project, such as those related to commercial, industrial, and event buildings, facilities, and equipment of all types. For the sake of non-limiting example, a job site may include: an oil and gas field in which personnel work on the maintenance of certain oil and gas equipment; a commercial building construction site in which personnel work on the construction of such building; an industrial facility in which personnel work on the assembly of certain items or components; a venue in which personnel work and collaborate to ensure an event proceeds as planned; and/or substantially any other site in which personnel may require the use of hand tools or radios to perform project-specific job tasks. In conventional systems, manual tool audits, pen and paper documentation, and other methods are conventionally used for specific tool vending and management, which can be inefficient and costly. Further, such conventional systems often lack the ability to determine in real time the location of such hand tools and/or the utilization of such over the course of the job, thereby leading to a lack of actionable data for which is used to efficiently manage the current job site, plan proactively, and right-size any subsequent projects.

To mitigate these and other challenges, the self-inventorying tool containers of the present disclosure use short-range wireless signals (such as certain Bluetooth signals) to track a location of hand tools associated with the self-inventorying tool container. For example, the self-inventorying tool container may include a plurality of hand tools therein (e.g., certain drills, impact wrenches, saws, welding equipment, radios, and/or any other appropriate equipment) that are each affixed with a beacon. The beacon may be Bluetooth low energy beacon and/or other device that is configured to periodically transmit a signal therefrom. The self-inventorying tool container may in turn include a scanning assembly that is configured to detect signals from each beacon, which is affixed to a respective tool of the plurality of hand tools. The scanning assembly, in cooperation with a processing unit and other associated modules (as described herein) may use said detected signal from the beacons to determine a location of the trackable construction tools as being within the self-inventorying tool container, outside of the self-inventorying tool container, and/or being absent altogether (i.e., the beacon and associated tool is no longer on the job site, such as being outside the range of the scanning assembly). For example, the processing unit may be used to determine a Received Signal Strength Indicator (RSSI) value or other indicator of signal strength for the respective beacon, and to correlate said signal strength with a location of the beacon relative to the tool container (e.g., where a strong RSSI value may indicate a trackable tool is held within the tool container, a weak RSSI valve may indicate that said trackable tool is outside of the tool container, among other configurations). Such location information and other metrics may be transmitted to a remote location, including a central server, using an antenna and other components associated with the self-inventorying tool container.

The foregoing functionality of the self-inventorying tool container provides for the efficient management of hand tools, equipment, and/or inventory on the job site. For example, the self-inventorying tool container may be configured to determine the duration that a given trackable hand tool is disposed outside of the container, an identity of a worker who is using the tool, a status of the tool, and other data points that can be used by a processing unit and/or other components of the container to deliver job site tailored recommendations that support the vending of tools in a fit-for-purpose manner. To illustrate, in one example, the self-inventorying tool container may determine that a first trackable tool is disposed outside of the container for a 9 hours per day over the course of a given project, whereas as second trackable tool is disposed outside of the container for 6 hours per day, whereas a third trackable tool is almost never disposed outside of the container. The self-inventorying tool container may use these and other metrics to determine that the first tool is over utilized (and thus additional such first tools should be supplied to the job site or subsequent project), the second tool is properly utilized, and the third tool is not needed for these types of jobs. Such utilization data may be further associated with an identity of the worker accessing the trackable tool, such as via an access management system of the container that permits retrieval of the tool upon receipt of a worker-specific code or other identifier. Continuing the non-limiting example, use of the first tool for 9 hours by a first worker may indicate that said first worker requires additional training to the extent that the job task for said first tool should have required only a few hours. In some cases, the self-inventorying tool container may further analyze this data and associate it with additional data points relating to the status of the tools and need for repair or replacement. Again, continuing the non-limiting example, the self-inventorying tool container may determine that the first tool needs battery replacement or inspection in view of its absence (and use) from the container for nine hours. Such information pertaining to the condition of a given tool may be further provided or supplemented via additional sensors and connections within the container itself, for example, such as sensors that receive a signal from the tool indicate of a status of the tool, including battery life. In other cases, other functions and features of the self-inventorying tool container are possible and contemplated herein.

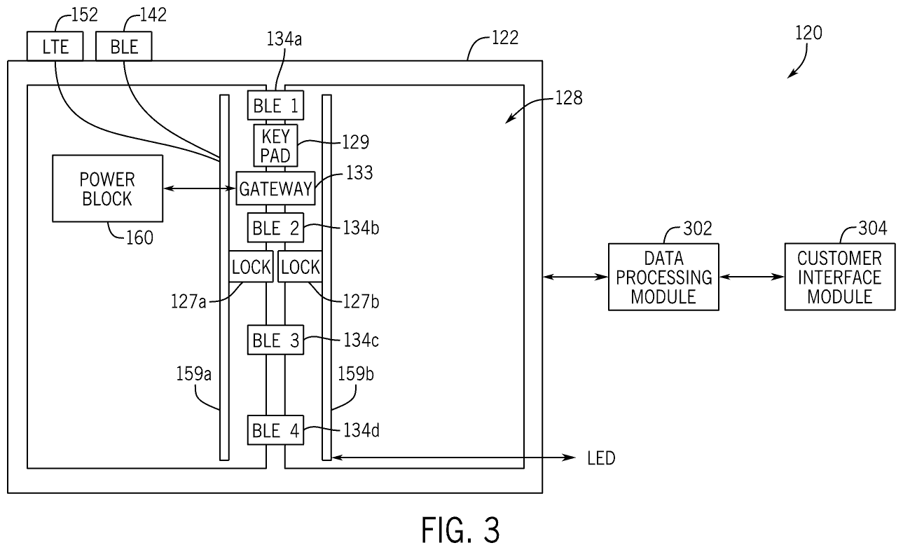

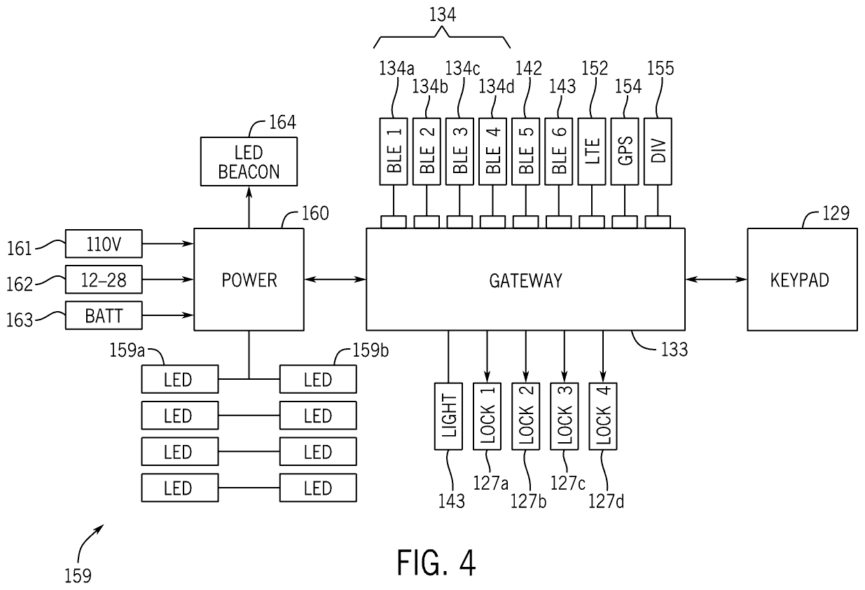

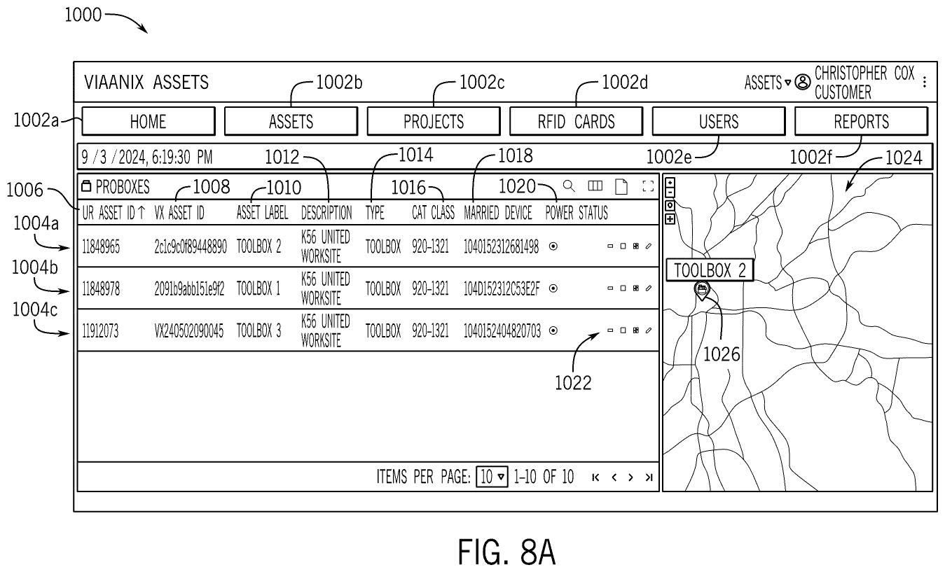

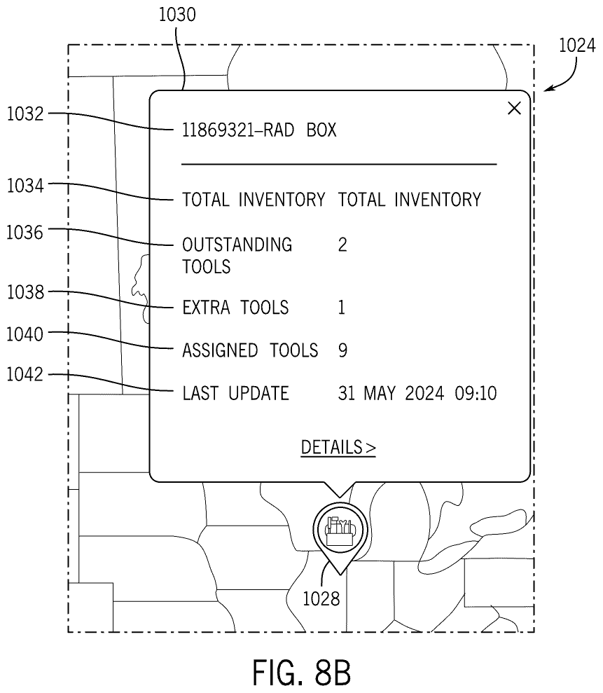

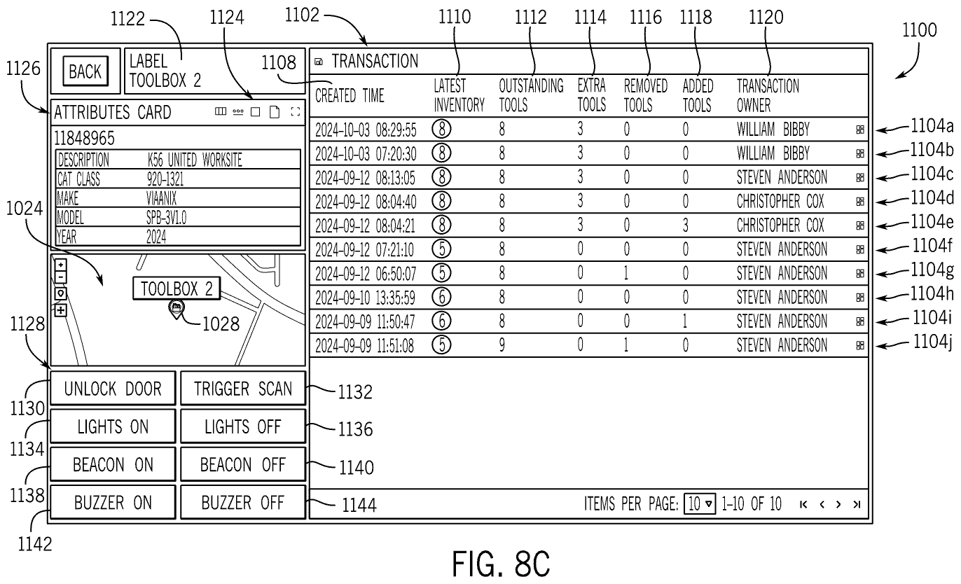

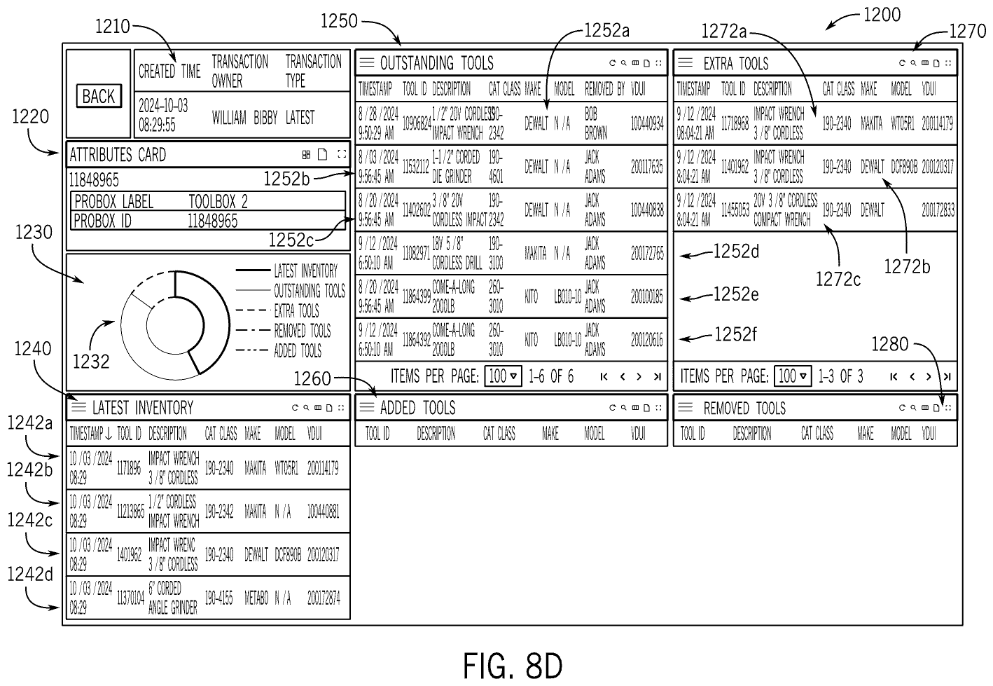

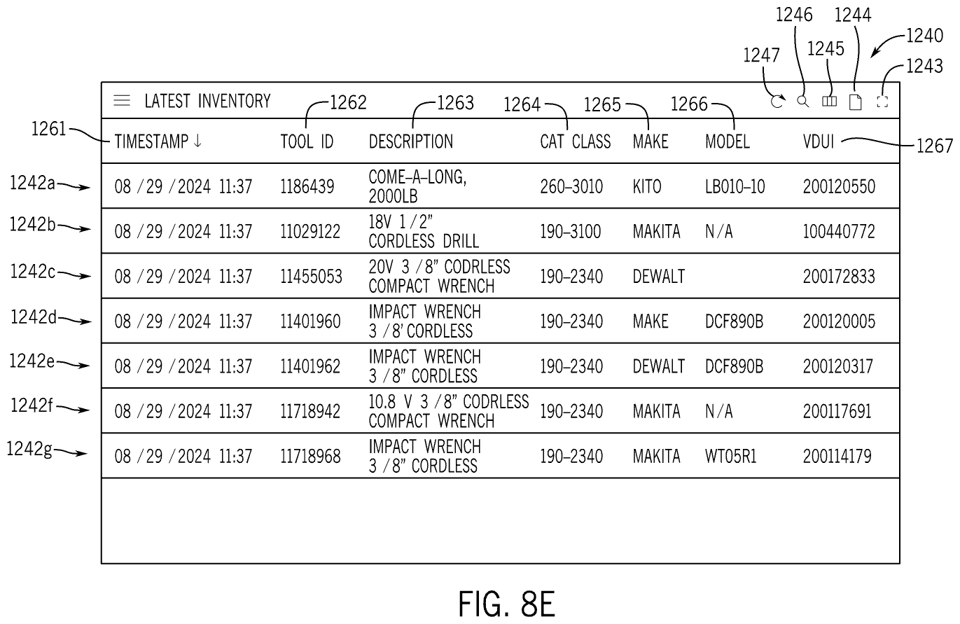

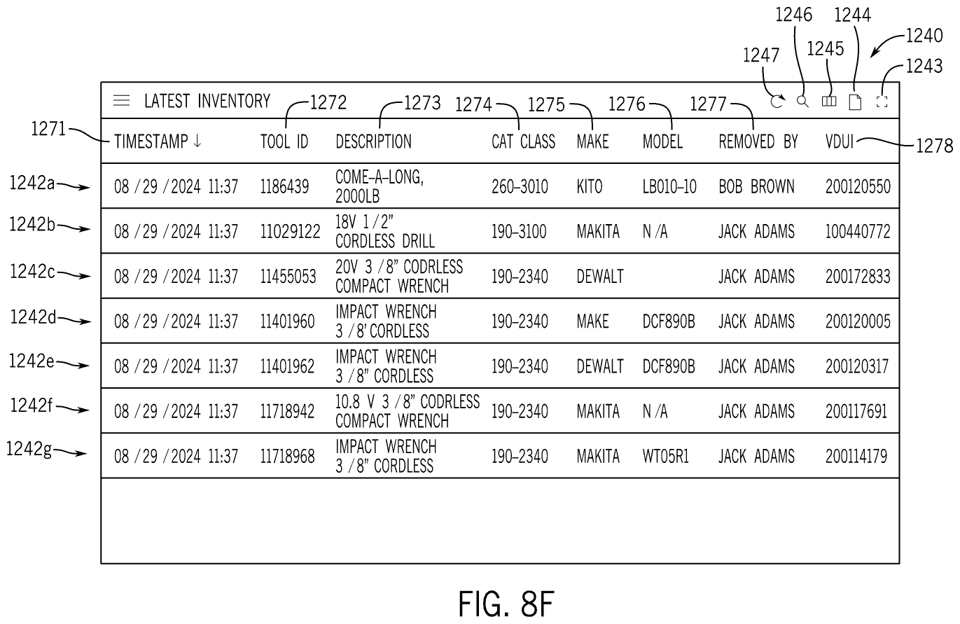

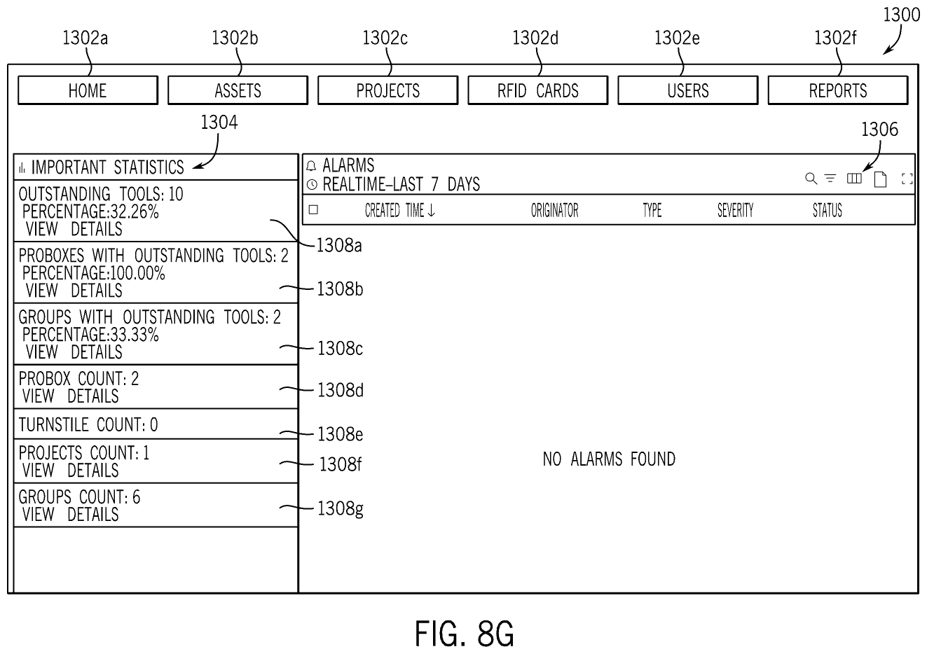

The present disclosure contemplates a reporting interface for presenting metrics associated with and/or captured by the self-inventorying tool container. The reporting interface may comprise a plurality of navigable user interfaces configured to display information and data collected and/or produced by the self-inventorying tool container to a user, thereby presenting them with actionable metrics to better manage one or more self-inventorying tool containers and/or job site. Such user interfaces may be a Graphical User Interface (GUI) displayed on a computing device such as a computer, mobile phone, tablet, etc. To facilitate the foregoing and as discussed in greater detail with reference to FIGS. 3-4, the Bluetooth gateway may receive a plurality of data points concerning the location and use of the beacons (and consequently the trackable tools); such data may then be transmitted, via an LTE module, to a remote computer, cloud computing platform, or the like where the plurality of navigable user interfaces may be displayed. As will be discussed in more detail with reference to FIGS. 8A-8F, the plurality of navigable user interfaces may be configured to provide the user with an overview or specific information pertaining to any equipment of the self-inventorying tool container. For example, the navigable user interfaces may display an overview of the number or proportion of missing trackable tools from any one or more self-inventorying tool containers. Additionally or alternatively, the navigable user interfaces may display the location of one or more self-inventorying tool containers overlayed onto a map. Additionally or alternatively, the navigable user interfaces may include a plurality of action buttons operable, upon selection, to send commands to one or more self-inventorying tool containers. Advantageously, the navigable user interfaces of the present disclosure are operable to present information pertaining to data collected by one or more self-inventorying tool containers, such that an operator may be abreast, in real-time, of all metrics indicative of the effective utilization of tools on the job site.

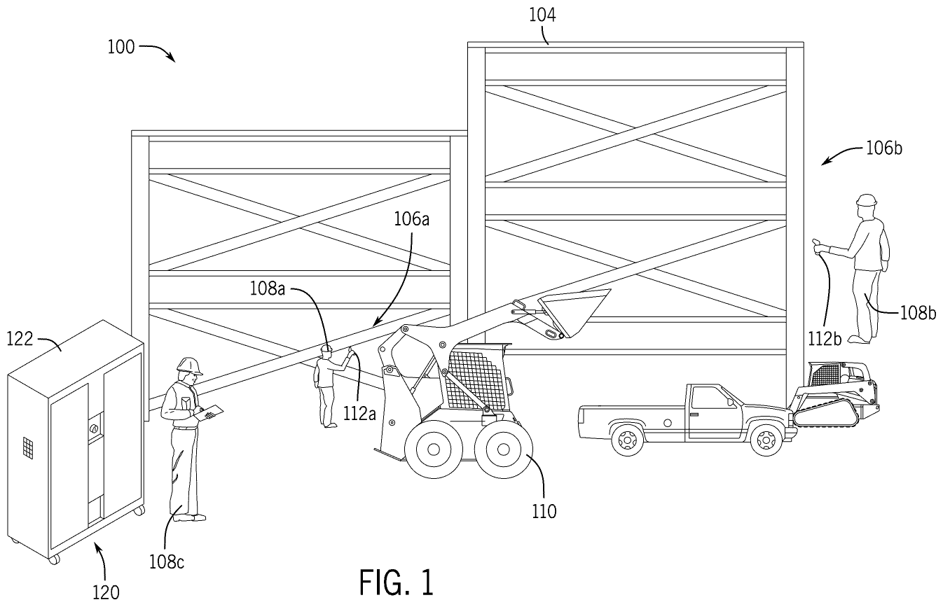

Turning to the Drawings, FIG. 1 depicts an example job site 100 including an example self-inventorying tool container 120, such as the self-inventorying tool containers discussed generally above and described in greater detail below. The job site 100 is shown as a general construction site for assembly of a building 104, and is presented for purposes of illustration; however, as described herein, the job site 100 may be any site in which personnel are engaged in the collective completion of a construction, maintenance, and/or event related project. The job site 100 is further shown as including a plurality of workers (workers 108a, 108b, 108c), including a first worker 108a engaged in a first job task 106a using a first trackable tool 112a, and a second worker 180b engaged in a second job task 106b using a second trackable tool 112b. The job site 100 may further include example equipment 110.

The self-inventorying tool container 120 is shown as including a tool container structure 122. Broadly, the self-inventorying tool container 120 may be provided to the job site 100 including a plurality of trackable construction tools or equipment therein, including, for example, the trackable construction tools 112a, 112b. The self-inventorying tool container 120 may actively scan an interior of the tool container structure 122 to determine a presence of said tools and equipment therein. At the job site 100, workers 108a, 108b, 108c may require use of the trackable construction tools held within the container structure 122 for a limited period of time. For example, the first worker 108a may require the first trackable tool 112a (e.g., an impact wrench) to complete the first job task 106a (e.g., high torquing of bolted connections), while the second worker 108b may require the second trackable tool 112b (e.g., a drill) to complete the second job task 106b (e.g., prepping equipment mounts). The self-inventorying tool container 120 may facilitate controlled release of the trackable construction tools 112a, 112b to the respective workers 108a, 108b, for example, by keeping such tools locked within the container structure 122 until said worker enters a code or other identifier to release the tools to the appropriate worker. Further, the self-inventorying tool container 120 may operate (as described in further detail herein) to determine a location of the respective trackable construction tools 112a, 112b as being outside of the container structure 122 (and within the jobsite 100). In this regard, the job site may be efficiently managed by securely releasing and tracking the trackable construction tools over the duration of the building project, among other benefits contemplated herein.

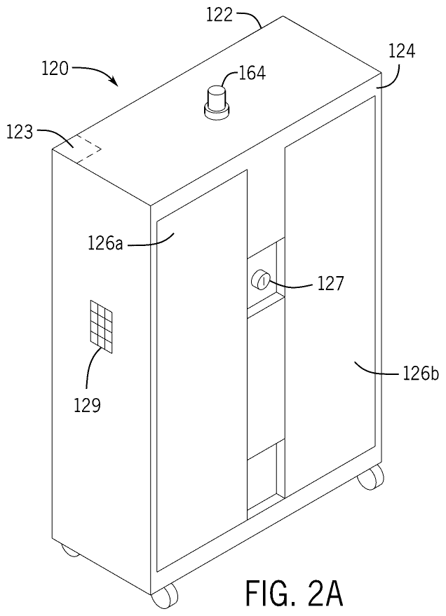

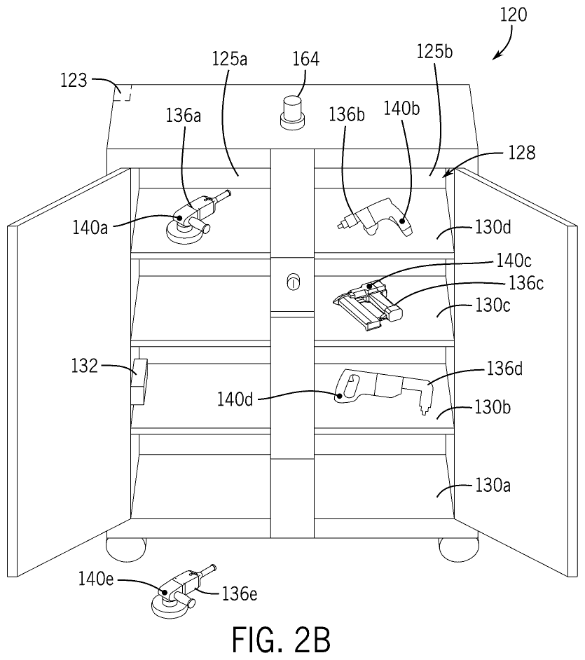

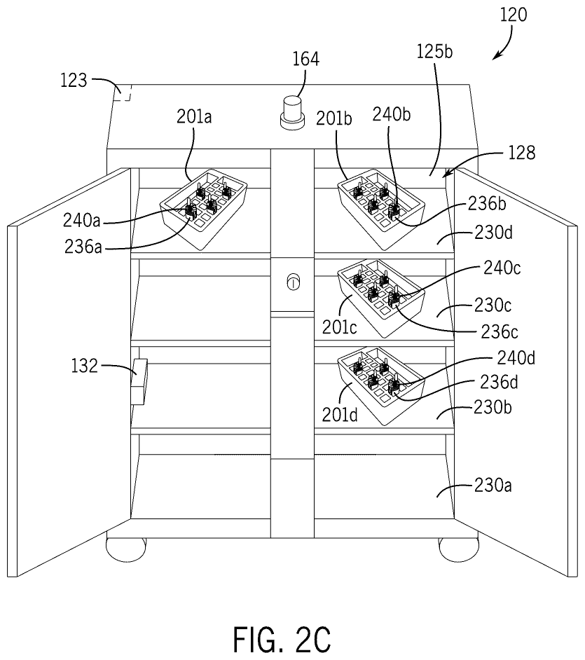

To facilitate the foregoing, by way of further example, the self-inventorying tool container 120 is shown in further detail in reference to FIGS. 2A-2C. In FIG. 2A, the self-inventorying tool container 120 is shown in a closed or secure condition in which any trackable construction tools contained therein are concealed from view and locked therein pending release form authorized personnel. In FIG. 2B, the self-inventorying tool container 120 is shown in an open or released condition in which the trackable construction tools held therein are revealed such that the authorized personnel may retrieve or return a given trackable tool. In FIG. 2C, the self inventorying tool container 120 is shown in an open or released condition in which trackable radios held therein are revealed such that the authorized personnel may retrieve or return a given trackable radio. One of ordinary skill in the art will appreciate that a variety of tools and equipment may be monitored, tracked, and inventoried by the self-inventorying tool container described herein and that such uses should not be limited to those specific examples depicted herein. For clarity, while the various functionalities of the self-inventorying tool container are described with reference to a construction site or a concert venue, the self-inventorying tool container may be configured to monitor, track, and inventory any type of hand-held physical equipment.

While many constructions are possible and contemplated herein, the self-inventory tool container 120 may include the tool container structure 122 that includes an enclosure 124 and doors 126a, 126b. The enclosure 124 may define an internal tool volume 128 therein and include a plurality of shelves (e.g., shelves 130a, 130b, 130c, 130d) for receipt of trackable construction tools and/or other equipment or sensors of the container 120. The doors 126a, 126b may be coupled with the enclosure 124 and operable to permit selective access to the internal tool volume 128 and any trackable construction tools held therein. While the tool container structure 122 is shown for purposes of illustration in FIGS. 2A and 2B as having a volume (e.g., 7 cubic feet, 16 cubic feet, and so on) sufficient to house 6 to 12 hand tools, in other examples, the tool container structure 122 may be smaller or larger, and have a different shape, based on a given application and usage.

The self-inventorying tool container 120 is shown in FIGS. 2A and 2B as including a plurality of trackable construction tools, such as a first trackable tool 136a, a second trackable tool 136b, a third trackable tool 136c, a fourth trackable tool 136d, and a fifth trackable tool 136e. The trackable construction tools 136a-136e may be any of a variety of hand tools, such as various powered, pneumatic, or hydraulic tools, including certain drills, wrenches, grinders, saws, and so on, shown for purposes of illustration. Each trackable tool of the plurality of trackable construction tools may be affixed with a beacon that is configured to transmit a short range wireless signal, such as a Bluetooth low energy and/or other like signal. In this regard, the first trackable tool 136a is show affixed with a first beacon 140a, the second trackable tool 136b is shown affixed with a second beacon 140b, the third trackable tool 136c is shown affixed with a third beacon 140c, and the fourth trackable tool 136d is shown affixed with a fourth beacon 140d, and the fifth trackable tool 136e is shown affixed with a fifth beacon 140e; in other cases, more or fewer trackable construction tools and beacons may be used. As described herein, the beacons 140a-140e may transmit such short range wireless signals (each a “tool signal”) periodically, both inside and outside of the container structure 122. Such signals may be unique to or otherwise keyed to or associated with each particular trackable tool. Accordingly, based on a receipt of said tool signal, the self-inventory tool container 120 may determine at least a location of said specific tool as being either within the internal volume 128 or outside of the internal volume 128 (and on the job site, such as being within the job site 100).

To facilitate the foregoing, the self-inventorying tool container 120 may include at least a scanning assembly 132. Broadly, the scanning assembly 132 may be arranged within the tool container structure 122 (e.g., within the internal tool volume 128) and configured to detect the short-range wireless—“tool signals”—of each of the beacons 140a-140e. In this regard, the scanning assembly may detect each such tool signals relative to a location of the internal tool volume 128 such that the scanning assembly 132 may be used to determine a location of each associated tool based in part of a strength and directionality of each respective signal. As described in greater detail herein in reference to FIGS. 3 and 4, the scanning assembly 132 may include or be associated with a Bluetooth gateway, and collection of Bluetooth low energy scanners (including associated antennas), whereby the collection of such gateway, scanners, and antennas may operate to capture the signal from each respective beacon to determine said location.

With continued reference to FIGS. 2A and 2B, the self-inventorying tool container 120 is shown as including an antenna 123. Broadly, the antenna 123 may be arranged with the tool container structure 122 and may be configured to transmit a signal (each a “container signal”) indicative of a location of each trackable construction tools 136a-136e to a remote location or remote server. In this regard, the antenna 123 may include a long-range wireless signal antenna, including certain cellular antennas to facilitate transmission directly from the job site to the remote location. The transmission of such container signals by the antenna 123 may permit the self-inventorying tool container 120 to provide data in substantially real time to a remote operations center or other location for further analysis and reporting the usage of the trackable construction tools, among other functions. The self-inventorying tool container 120 is further shown as including an indicator 164, which may be configured to generate an audio and/or visual alert in response to one or more events. For example, the indicator 164 may be configured to generate the audio and/or visual alert in order to indicate the presence of a tool of interest within a given self-inventorying tool container of a job site, an evacuation event (including evacuation path and severity), and/or in response for the given self-inventorying tool container remaining open for predefined period (e.g., such as being open for longer than 2 minutes, 3 minutes, 4 minutes and/or other predefined period).

FIGS. 2A and 2B further show certain components of the access management system of the self-inventorying tool container 120, including the keypad 129 and a locking handle 127. Broadly, the self-inventorying tool container 120 may serve to secure access to the trackable construction tools 136a-136e when not in use, and to permit access to such tools only to certain authorized personnel upon receipt of a uniquely identifying code or other indicator of access. For example, upon receipt of a uniquely identifying code at the keypad 129, the locking handle 127 may permit a worker to open doors 126a, 126b and reveal the interior tool volume 128 and any trackable construction tools held therein. The opening of the doors 126a, 126b may therefore be associated with the specific worker for the uniquely identifying code. In this regard, as one or more trackable construction tools 136a-136e are removed from the interior tool volume 128 during the worker-specific period for which the doors 126a, 126b are opened, the self-inventorying container 120 can further associate the specific worker with such removed trackable construction tools based on the change in each tools respective tool signal.

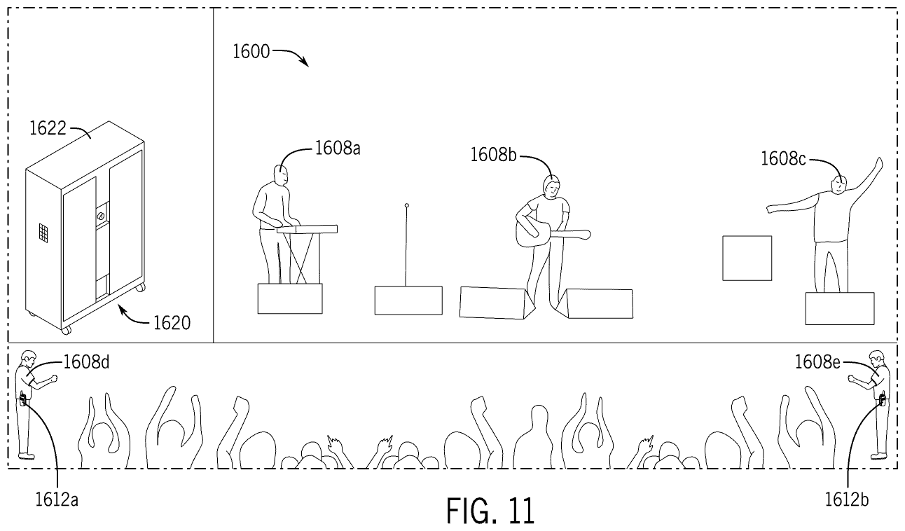

The self-inventorying tool container 120 is shown in FIG. 2C as including a plurality of trackable radios, and in many respects is substantially analogous to that depicted in FIG. 2B, redundant explanation of which is excluded for clarity. However, FIG. 2C exemplifies the variety of use cases for the self-inventorying tool container 120. For example, and with reference to FIG. 11, the self-inventorying tool container 120 may be employed at a concert and/or other venue and include a plurality of radios, such as those used by venue personnel and performers to provide proper communication to ensure the planned event is effectuated according to plan. In this regard, FIG. 2C illustrates a plurality of containers 201a-201d each including at least one radio (i.e., radios 236a-236d) including a beacon (i.e., beacons 240a-240d). For clarity and used herein, trackable tools may include equipment such as radios, cellphones, pagers, and other communication devices. Analogous to that as described above in relation to FIGS. 2A and 2B, the beacons 240a-240d may be used to determine a position of the radios 236a-236d as being inside or outside of the self-inventorying tool container 120, according to the techniques described herein.

To facilitate the foregoing functionality of the self-inventorying tool container 120, FIGS. 3 and 4 depict example functional components of the self-inventorying tool container 120 for purposes of illustration. As shown in FIG. 3, the self-inventorying tool container 120 may include a gateway 133 and plurality of internal scanning devices, such as Bluetooth low energy (“BLE”) antenna 1 (134a), BLE antenna 2 (134b), BLE antenna 3 (134c), and BLE antenna 4 (134d). Each internal BLE antenna of the plurality of internal BLE antennas 134a-134d may be capable of receiving a Bluetooth low energy or other like signal, and transferring that signal and/or other associated signals to the gateway 133. The plurality of BLE antennas 134a-134d may be configured to detect a tool signal from any of the trackable construction tools that are disposed within the internal tool volume 128. In turn, the Bluetooth gateway 133 may receive each respective tool signal from the BLE antennas 134a-134d, and process the signals for analysis and determination of a location of the respective tools, often in conjunction with one or more processing units, described herein.

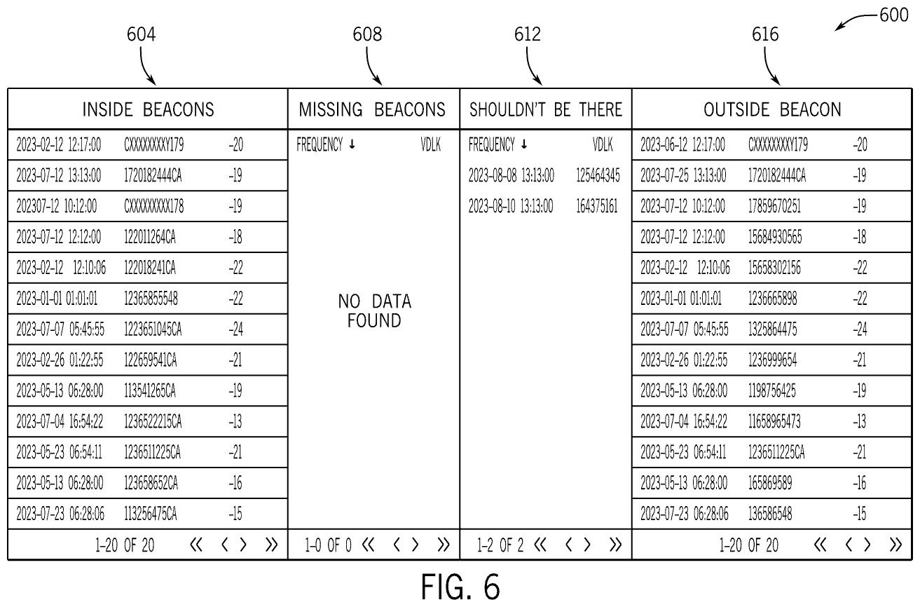

By way of further example, the functional diagram of FIG. 3 further shows an external scanning BLE antenna 142 coupled to the Bluetooth gateway 133. The external scanning BLE antenna 142 may also be configured to detect a tool signal, but may be further arranged and configured to detect said tool signals that originate outside of the internal volume 128. For example, the external scanning BLE antenna 142 may be operable to detect the tools signal at a range of around 300 meters from the internal tool volume 128. In turn, the Bluetooth gateway 133 may receive such tool signals from the external scanning BLE antenna 142, and process the signals for analysis and determination of a location of the respective tools, often in conjunction with one or more processing units. The information received and processed via the gateway 133 may, in some cases, be transmitted to an external system, such as a cloud computing platform, user endpoint device (e.g., mobile phone, laptop, and so) via an LTE antenna 152. In this regard, the self-inventorying tool container 120 is shown communicatively coupled with a remote data processing module 302. The remote data processing module 302 may be a remote or cloud computing system that is operable to receive raw data from the self-inventorying tool container 120, for example, via the LTE antenna 152. The data processing module 302 may be adapted to process said raw data and output said raw data into a format capable of receipt by a customer interface module 304, at which the formatted data is transformed into one or more user interfaces (e.g., such as the user interfaces shown and described herein in relation to FIG. 6). In other cases, such user interfaces may be generated directly by the data processing module 302.

The functional diagram of FIG. 3 further shows additional features of the access management system described above in relation to FIGS. 2A and 2B as being coupled to the gateway 133, including locks 127a, 127b for the locking handle 127. In some cases, optional door sensors may also be provided that include a variety of sensing mechanisms, including contact based sensors, that provide an indication of the status of the doors 126a, 126b as being in either the closed or open configuration. Such door sensors may provide a signal to the gateway 133 and/or other processing unit of the self-inventorying tool container 120 that is used to determine a period or duration for which the container 120 remains in the open configuration. This may allow the self-inventorying tool container 120 to determine that a particular trackable tool is being removed from the internal tool volume 128 (as detected by the BLE antennas 134a-134d) for the given period for which the doors remain open. Accordingly, because the doors should open only in response to a particular authorized user, the removal of the trackable tool can, in turn, be associated with such user. Further, the locking handle 127 can provide an indication to the gateway 133 and/or other processing unit of the self-inventorying tool container 120 that the internal tool volume 128 is locked, and as such, the subsequent removal of tools from the internal tool volume will not be associated with the user. Further, LEDs 159a, 159b may be operable to illuminate the internal tool volume 128 when the doors 126a, 126b are arranged in an open configuration. The gateway 133 is shown in FIG. 3 as being powered by the Power Block 160, which as described and show in greater detail in relation to FIG. 4 may be operable to provide power to the self-inventorying tool container 120 via 110V AC, 12-28V DC, solar, battery DC.

With reference to FIG. 4, the functional components of the self-inventorying tool container 120 are shown in additional detail. For example, the gateway 133 is shown operatively connected to the plurality of BLE antennas 134 (e.g., the BLE antenna 1 (134a), the BLE antenna 2 (134b), the BLE antenna 3 (134c), and the BLE antenna 4 (134d)), any of which may be used to determine the location of one or more trackable tools as being within the internal volume 128. The gateway 133 is further shown as operatively connected to the BLE antenna 5 (142), which as described in relation to FIG. 3 may be used to determine a location of one or more trackable tools as being outside of the tool volume 128. It will be appreciated that the gateway 133 may be operatively associated with numerous additional BLE antennas as may be needed to facilitate a given application, including having more or fewer BLE antennas employed to detect BLE signals both inside and outside of the internal tool volume 128. In this regard, FIG. 4 show a BLE antenna 6 (143) operatively coupled to the gateway 133, which may be a BLE antenna that is operable to detect signals from within or outside the tool volume 128 as needed. In some cases, one or more of the BLE antennas described herein may be optionally used for obtaining and/or processing signals for determining an angle or arrival (“AoA”) and/or an angle of departure (“AoD”) for refined tool location calculation relative to the internal volume 128.

With continued reference to FIG. 4, the gateway 133 is shown operatively connected to an LTE module 152, a GPS module 154, and a DIV module 155. The LTE module 152 may include any appropriate antenna or other feature that is capable of transmitting cellular signals. For example, the LTE module 152 may send and receive signals to a cloud computing platform in order to send and receive raw data with the self-inventorying tool container 120 for performing one or more of functions described herein. The GPS module may be used to determine the current position of the self-inventorying tool container 120, which may be desirable for determining a location of said container 120 on the jobsite 100. The DIV module 155 may be used to perform one or more auxiliary signal sending/receiving functions, including those that may be customer programmed for a given self-inventorying tool container 120.

As further shown in FIG. 4, the self-inventorying tool container 120 may include lock modules 127a-127d that are operatively connected to the gateway 133. For example, the self-inventorying tool container 120 may include one or more doors, access points, and/or other features that permit the internal tool volume 128 to be repeatedly concealed and restricted from unauthorized access. In one example, each of the lock module 127a-127d may be arranged to generate a signal responsive to the opening of such corresponding feature, and send said signal to the gateway 133. In this regard, the gateway 133 may receive an indication that the internal tool volume 128 is open, and that a particular door of the container 120 remains open. Correspondingly, the lock module 127a-127d may further be arranged to generate a signal responsive to the closing of the corresponding door or feature such that the gateway 133 receives an indication of the internal tool volume 128 being closed. In some cases, a light 143 may be operatively connected to the gateway 133 and operative to illuminate in response to one or more of the lock modules 127a-127d indicating that internal tool volume 128 remains open.

As further shown in FIG. 4, the self-inventorying tool container 120 may include the power module 160. The power module 160 may be associated with various components for providing a continuous supply of power to the self-inventorying tool container 120, including a 110V AC module 161, a 12-28V DC module 162, and/or a battery module 163. The 110V AC module 161 may include any appropriate electric connections to support the provisions of AC power to the self-inventorying tool container 120. The 12-28V DC module 162 may include any appropriate electric connections to support the provision of DC power to the self-inventorying tool container. The battery module 163 may include any appropriate power pack (including solar capabilities) to support the provision of power to the self-inventorying tool container 120 free from direct AC or DC power connections. In some cases, the power module 160 may also include one or more associated modules that may facilitate the wireless or hard-wired powering of trackable tools that are held within the internal tool volume. On charging of any trackable tools in this manner, the gateway 133 may receive information associated with the same in order to develop the tool health, usage, and other reports and functionalities contemplated herein.

As further shown in FIG. 4, the power module 160 is coupled with an LED beacon 164, such as that shown and generally described above in relation to FIGS. 1-3. The LED beacon 164 may be arranged outside of the container 120 and operable to emit an audio and/or visual signal responsive to one or alert events, including an alert that a given tool is arranged within the internal tool volume 128, an alert regarding an evacuation of a job site, and/or other alert, including custom programmed alerts. Further, LED bank 159 is shown operatively coupled with the power module 160, which includes the LEDs 159a, 159b, among optionally many others. In this regard, the LED bank 159 may include any of a plurality of lights arranged within the internal volume 128 (or optionally outside of the volume) to support the use of the container 120 and access of any trackable tools held within the internal tool volume 128.

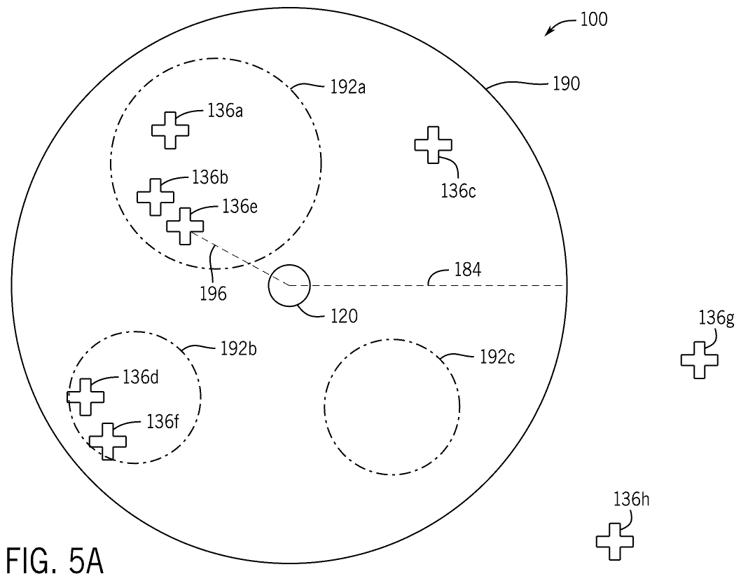

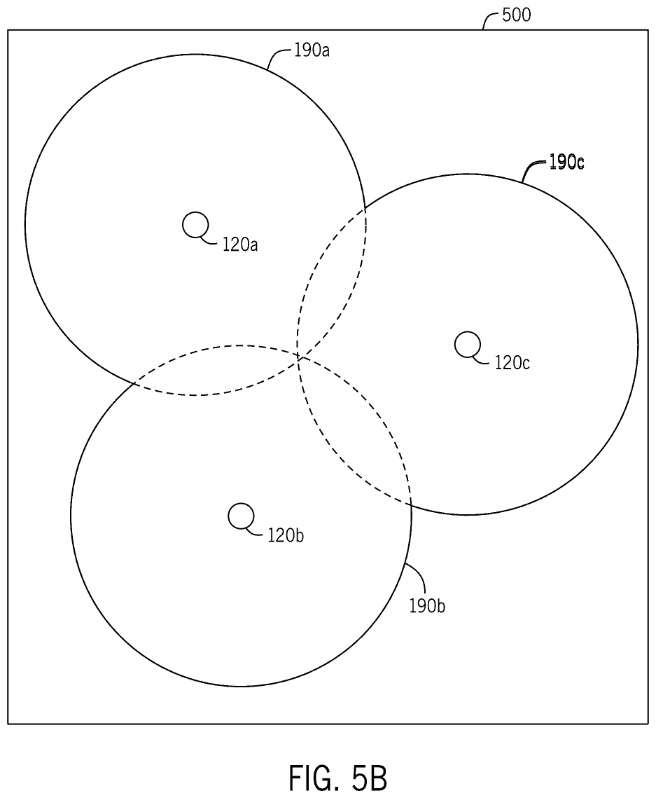

FIG. 5A depicts a schematic top view of the example job 100 site of FIG. 1 including the example self-inventorying tool container 120. The self-inventorying tool container 120 may be configured to determine a location of the trackable construction tools within a trackable region 190 from the container 120. The trackable region 190 may in some circumstances be defined by a trackable radius 184 of around 300 meters; however, in some cases, the trackable radius 184 may be more or less than 300 meters as needed for a given application. The self-inventorying tool container 120 may be configured to determine a location of trackable construction tools within the trackable region 190, for example, such as determining that a trackable tool 136e is arranged at a location at a distance 196 from the self-inventorying tool container 120. In some cases, the self-inventorying tool container 120 may determine, based on the location of trackable construction tools, that the trackable construction tools are be used on or otherwise associated with a specific job task or sub region of the trackable region 190; such as determining that trackable construction tools 136a, 136b, 136e are each associated with a job task region 192a, trackable construction tools 136d, 136f are associated with a job task region 192b, and no trackable construction tools are associated with job task region 192c. Such analysis can provide real-time metrics indicative of the effective utilization of tools on the job site, for example, by indicating which tools are being used for which job task, and even where tools are being used for other non-assigned job tasks (e.g., such as where trackable tool 136c should be associated with the job task region 192c but is otherwise absent therefrom). The self-inventorying tool container 120 may also provide an indication of trackable construction tools that are missing altogether from the job site 100, such as may be the case for trackable construction tools 136g, 136h, which are shown as being outside of the trackable region 190.

It will be appreciated that multiple self-inventorying tool containers 120 may be used on a single job site. In this regard, FIG. 5B shows a job site 500 including a first self-inventorying tool container 120a, a second inventorying tool container 120b, and a third self-inventorying tool container 120c, each of which may be substantially analogous to the self-inventorying tool container 120 described herein. Multiple such containers may be provided to the job site 500 in order to maximize the region across which trackable tools may be detected. For example, the first self-inventorying tool container 120a may be associated with a first trackable region 190a, the second self-inventorying tool container 120b may be associated with a second trackable region 190b, and the third self-inventorying tool container may be associated with a third trackable region 190c, with such trackable regions, collectively, covering a majority of the footprint of the job site 500. Furthermore, the containers 120a-120c may be coupled to one another in order to provide information concerning the location of specific a trackable tool as among the containers 120a-120c. For example, personnel on the job site 500 may access a mobile device and query the location of a specific tool. Said personnel may receive an indication of the specific container of the containers 120 that the given trackable tool is located. Further, the LED beacon or other alerting device of the container 120 may produce an alert at the particular container 120 where the trackable tool is located. Further, each of the containers 120 may cooperate to produce other alerts that support personnel and job site safety, including evacuations. For example, in response to an evacuation event on the job site for any number of job site-specific safety rationales, the containers 128 may produce an audio or visual alert that indicate the evacuation event and/or type. In some cases, the alerts may be sequenced to indicate one or both of an evacuation route or a severity of an evacuation event, among other options.

FIG. 6 depicts an example report 600 of trackable construction tools or equipment for any of the self-inventorying tool containers described herein. For example, the report 600 may be used to provide information concerning beacons (and the associated trackable construction tools) that are inside the container (e.g., as depicted at “Inside Beacons” column 604). The report 600 may be further used to provide information concerning beacons (and associated trackable construction tools) that are missing from the container and job site (e.g., as depicted at “Missing Beacons” column 608). The report 600 may be further used to provide information concerning beacons (and associated trackable construction tools) that should not be in the container (e.g., as depicted at “Shouldn't Be There” column 612). The report 600 may be further used to provide information concerning beacons (and associated trackable construction tools) that are outside of the container but remaining trackable on the job site (e.g., as depicted at “Outside Beacon” column 616). In other cases, other information may be provided as needed for a given application. In various examples, the example report 600 may be displayed on the plurality of navigable user interfaces such as certain graphical user interfaces or “GUIs.”

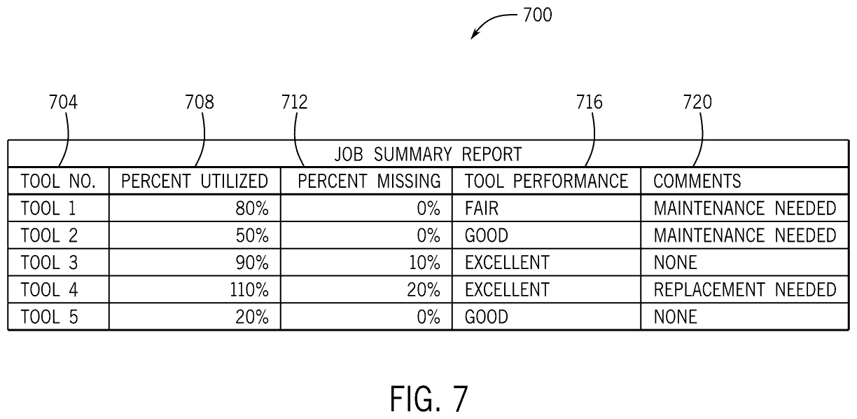

FIG. 7 depicts another example report 700 of trackable construction tools for any of the self-inventorying tool containers described herein. The example report 700 shows that status of various trackable construction tools (e.g., “Tools 1-5”) of the container used on the job site (e.g., as depicted at the “Tool No.” column 704). The example report 700 further shows the percentage that each such tool was utilized on the job site (e.g., as depicted at the “Percent Utilized” column 708). The percent utilization may be indicative of a time that said tool was located outside of the tool container and on the job site. Further, the example report 700 shows the percentage that each such tool was missing from the job site (e.g., as depicted at the “Percent Missing” column 712). The percent missing may be indicative of the time that said tool was location outside of the job site, and thus could not be tracked by the self-inventorying tool container 120. Further, the example report 700 shows a performance metric for each such tool (e.g., as depicted at the “Tool Performance” column 716). The tool performance may be indicative of a battery life of the respective tool and/or other metric of tool health, which may be supplemented by additional sensors of the container 120 and/or delivered to the container 120 via onboard diagnostics from the tool itself. Further, the example report 700 shows a comments field for each such tool (e.g., as depicted at the “Comments” column 720). The comments for each tool may be a recommended course of action for the given tool, as developed by the self-inventorying tool container, associated processing units, and/or remote servers, prior to the delivery of the container 120 to the next job site, based on one more or criteria, including the metrics for each tool listed in the percent utilized column 708, the percent missing column 712, and the tool performance column 716. In other cases, other information and reports may be provided as needed for a given application. In various examples, the example report 600 may be displayed on the plurality of navigable user interfaces.

The information and data collected by the self-inventorying tool container of the present disclosure may be displayed on a platform (i.e., remote computer, computer application, cloud service, Software as a Service (Saas), mobile application, or the like) via a variety of navigable user interfaces, such that an operator may be kept informed of the status of one or more self-inventorying tool containers and trackable tools associated thereto. For example, the plurality of user interfaces described herein may display information concerning the beacons (and the associated trackable tools) that are inside the container, missing from the container, should not be included in the container, and/or any metrics associated with their use. In many examples, such metrics may be computed via Bluetooth gateway 133. In other examples, raw metric data may be sent to the platform by the Bluetooth gateway 133 and subsequently computed by a process of the platform. As another example, the plurality of user interfaces described herein may display information concerning an array of self-inventorying tool containers grouped or assigned to a particular job site and include their location and status. As another example, the plurality of user interfaces described herein may display information concerning the workers or users of the trackable tools, such as their role, permissions, and contact information. As yet another example, the plurality of user interfaces described herein may include a plurality of action buttons operable to remotely control one or more self-inventory tool containers, such as locking the container, sounding an alarm of the container, turning on or off lights of the beacons associated with the container, and/or triggering a scan.

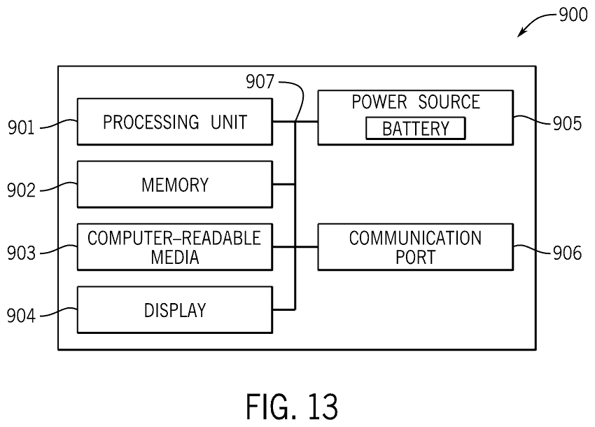

In this regard, FIGS. 8A-10 are described in turn below, which depict certain functional capabilities facilitated by the self-inventorying tool containers described herein. For example, the self-inventorying tool containers described herein may be communicatively coupled with certain servers and remote computing devices (such as that shown in relation to FIG. 13), which may be used to generate one or more of the interfaces described in relation to FIGS. 8A-10 when used in conjunction with the self-inventorying tool containers of the present disclosure. The interface and functions described in FIGS. 8A-10 may therefore be used to support real-time tool inventory management and job site control.

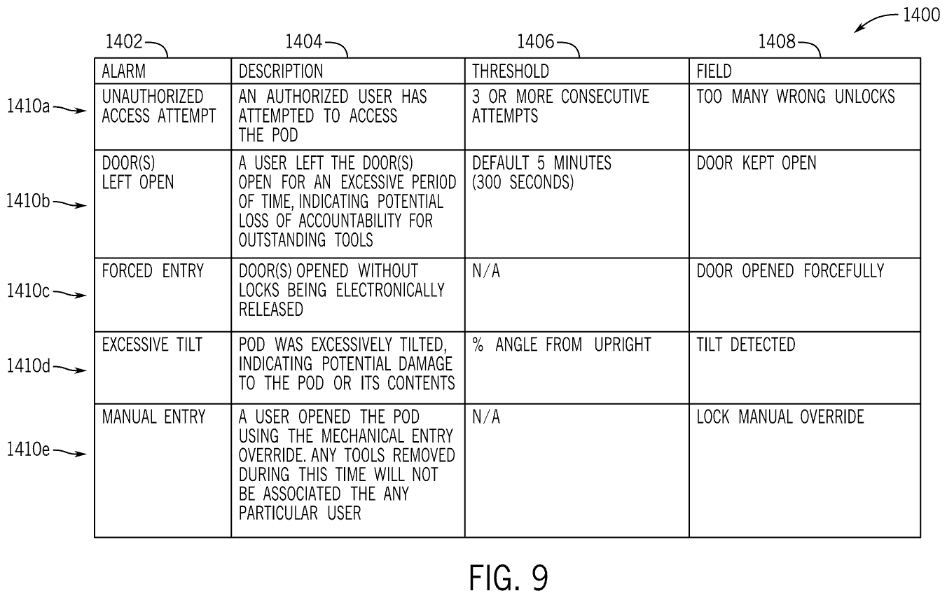

For example, for purposes of illustration, FIG. 8A depicts a user interface 1000 of self-inventorying tool container dashboard. User interface 1000 may serve as a home page listing one or more self-inventorying tool containers managed, owned by, and/or otherwise in control of the user navigating user interface 1000. For example, self-inventorying toolbox 1004a-1004c indicia shown in FIG. 8A may represent the toolbox 120 (and associated job site 100 or jobsite 1600 or other jobsite). In several examples, user interface 1000 includes a plurality of navigation buttons operable to navigate to other user interface pages. For example, user interface 1000 includes a home page button 1002a operable to navigate the operator to a home page of the platform; an assets page button 1002b operable to navigate the operator to user interface 1000; a project page button 1002c operable to navigate the operator to a projects page displaying information pertaining to one or more self-inventorying tool containers within a specific geolocation or assigned to a specific job; an RFID Cards page button 1002d operable to navigate the operator to an RFID page to alter permissions of users or workers and/or to assign RFID cards to individuals for NFC authentication; a users page button 1002e operable to navigate the operator to a user management page operable to enable the operator to create, edit, deactivate, and/or activate permissions of specific workers or users to certain self-inventorying tool containers (i.e., their ability to access self-inventorying tool containers). In several examples, assets page button 1002b may be included on other user interfaces and operable to navigate the user to user interface 1000. As another example user interface 1000 includes reports page button 1002f operable to navigate the operator to a reports management page that supports creation and/or alteration of report settings (i.e., content of reports, reoccurrence of reports, automation of reports, etc.), which is discussed in more detail with reference to FIG. 9.

In several examples, user interface 1000 includes a listing of self-inventorying tool containers 1004a-1004c managed by the operator and includes information pertaining to each self-inventorying tool container displayed therein. As described herein, each toolbox listing (e.g., listings 1004a-1004c) may correspond to a self-inventorying tool container such as that described with reference to FIGS. 1-5B. Additionally, as described herein, each “transaction” may refer to a trackable tool of a self-inventorying tool container, such as those described with reference to FIGS. 1-2C and FIG. 11. For example, user interface 1000 may include a listing including a first self-inventorying tool container 1004a, a second self-inventorying tool container 1004b, and a third self-inventorying tool container 1004c. However, the listing of user interface 1000 may include more or fewer self-inventorying tool containers, each of which may correspond to the self-inventorying tool container 120. The listing may further include a plurality of characteristic data columns pertaining to specific information of each self-inventorying tool container listed. For example, each listing (i.e., listing 1004a, 1004b, 1004c) includes a user asset ID (represented by data column 1006) displaying an asset ID recognizable or assigned by a user for the specific self-inventorying tool container; an administrator asset ID data column 1008 displaying an asset ID (represented by data column 1008) recognizable or assigned by an administrator for the specific self-inventorying tool container; an asset label (represented by data column 1010) displaying a label designated to the specific self-inventorying tool container; a description (represented by data column 1012) displaying a description of the specific self-inventorying tool container; a container type (represented by data column 1014) displaying a category of the type of the specific self-inventorying tool container; a category class (represented by data column 1016) displaying a category class of the specific self-inventorying tool container; a married device ID (represented by data column 1018) displaying an ID associated with a device related or otherwise connected to the specific self-inventorying tool container. In several examples, click selection of any of toolbox listings 1004a-1004c is operable to navigate a user to user interface 1200.

Each self-inventorying tool container listing (i.e., listing 1004a, 1004b, 1004c) may include a plurality of action buttons 1022 associated thereto operable to edit the listing, navigate to a user interface page specific to that listing (e.g., user interface 1100, user interface 1210, user interface 1300, etc.), delete the listing, etc.

In several examples, user interface 1000 includes a geolocation window 1024 displaying the specific geological location of any of the self-inventorying tool containers listed. Geolocation window 1024 includes a satellite image of a specific location. Geolocation window 1024 may include a pin 1026 representing the location of the self-inventorying tool containers listed in, for example, listing 1004a, 1004b, and 1004c. Geolocation window 1024 may be navigable to other locations where other self-inventory tool containers are located. Solely for illustrative purposes, geolocation window 1024 includes a single pin 1026; however, multiple pins may be displayed therein or may be outside of the current view of the geolocation window 1024.

FIG. 8B depicts a detailed view of geolocation window 1024 and further depicts an information box 1030, which may be identified with indicia 1032. Upon click selection or hovering action on a pin, for example pin 1028, information box 1030 may be displayed. Information box 1030 may include a summary of pertinent information associated with the specific self-inventorying tool container represented by pin 1028. For example, information box 1030 may include a total inventory count 1034 (representing the total number of trackable tools assigned to the container), an outstanding tools count 1036 (representing the number of trackable tools not currently within the container), an extra tools count 1038 (representing the number of trackable tools currently within the container but not assigned to that specific container), a total assigned tools count 1040 (representing the number of trackable tools assigned to that specific container), and a last update entry 1042 including a timestamp of the last scan conducted by the specific container. In several examples, each pin of the geolocation window 1024 may include an information box 1030 providing a summary of notable data associated with the specific self-inventorying tool container of interest.

FIG. 8C depicts a user interface 1100 of a self-inventorying tool container asset page. Particularly, user interface 1100 includes specific details pertaining to a given self-inventorying tool container. User interface 1100 may be accessed via selection of any of any of the container listings (i.e., listings 1004a, 1004b, 1004c) of user interface 1000. In several examples, user interface 1100 includes a container label window 1122 displaying a label or name associated with the specific container subject to user interface 1100. User interface 1100 may also include an attributes card window 1126 including information pertaining to the specific container subject to user interface 1100. For example, attributes card window 1126 includes a description of the container (e.g., location of the container, name of individual or group renting the container, label for the job site for which the container is assigned, etc.), a category class of the container, a make of the container, a model of the container, and/or the year the container was manufactured. The attributed card window 1126 may include a plurality of option buttons 1124. The plurality of option buttons 1124 may be selected to edit the view of the attributed card window 1126, export the information contained therein, expand or minimize attributed card window 1126, and/or navigate to other user interface pages.

In several examples, user interface 1100 includes a transaction listing 1102 including a plurality of recent transactions related to the specific container detailed by user interface 1100. As used herein, “transaction” refers to a trackable tool being taken from or returned to a self-inventorying tool container and may be tracked via the scanning assembly 132. For example, user interface 1100 includes transaction listing 1102 including a plurality of transactions (i.e., transaction 1104a, 1104b, 1104c, 1104d, 1104e, 1104f, 1104g, 1104h, 1104i, 1104j). In several examples, each transaction includes a plurality of metric data associated with each transaction and user interface 1100 includes several data columns to represent such metric data. For example, each transaction may include a creation timestamp (represented by created time data column 1108) including a timestamp of the time the transaction took place. In several examples, the timestamp is taken at the time of the most recent scan, for example by the scanning assembly 132, of the self-inventorying tool container. As another example, each transaction may include a latest inventory entry (represented by data column 1110) illustrating the number of trackable tools within the container based on that specific transaction; an outstanding tools entry (represented by data column 1112) illustrating the number of trackable tools absent from the container during the specific transaction; an extra tools entry (represented by data column 1114) illustrating the number of extra tools (i.e., those not assigned to the specific container) present in the container at the time of the transaction; a removed tools entry (represented by data column 1116) illustrating the number of trackable tools removed from the container (i.e., unassigned from the container) during the last transaction by an administrator of the specific container; an added tools entry (represented by data column 1118) illustrating the number of trackable tools added to the container (i.e., assigned to the container) during the last transaction by an administrator of the specific container; and a transaction owner entry (represented by data column 1120) illustrating the identity or label of the user or worker giving rise to the transaction (i.e., withdrawing or returning a trackable tool).

Similar to user interface 1000, user interface 1100 may include a geolocation window 1024 displaying the geological location of the container pertaining to the specific container subject to user interface 1100 via at least one pin 1028, redundant explanation of which is excluded herein for clarity.

In several examples, user interface 1100 includes an action buttons section 1128 including a plurality of selectable buttons configured to remotely send commands to the container subject to user interface 1100. In several examples, commands may be sent via a transmitter and may be received via LTE model 152. For example, the action buttons sections may include an unlock door button 1130 operable to unlock the doors (i.e., unlock lock handle 127) of the container subject to user interface 1100; a trigger scan button 1132 operable to trigger a scan (e.g., of scanning assembly 132); a lights on button 1134 operable to activate lights (e.g., LEDs 159a, 159b) of the container; a lights off button 1136 operable to deactivate lights (e.g., LEDS 159a, 159b) of the container; a beacon on button 1138 operable to activate an LED of the beacons assigned to the specific container; a beacon off button 1140 operable to deactivate an LED of the beacons assigned to the specific container; a buzzer on button 1142 operable to sound an alarm or noise from the beacons assigned to the specific container; a buzzer off button 1144 operable to turn off an alarm or noise form the beacons assigned to the specific container. Advantageously and with specific reference to buttons 1138, 1140, 1142, and 1144, the evacuation events described herein may be initiated or halted remotely via user interface 1100.

FIG. 8D depicts a user interface 1200 of a self-inventorying tool container details page. User interface 1200 may be accessed from either user interface 1000 or user interface 1100 via selection of a specific container. User interface 1200 includes a plurality of informational windows pertaining to actionable metrics of a single, specific self-inventorying tool container and advantageously provides an operator with a summary of information likely pertinent to the efficient use of the container. For example, user interface 1200 may include a recent transaction window 1210, an attributes card window 1220, an inventory graph window 1230, a latest inventory window 1240, an outstanding tools window 1250, an added tools window 1260, an extra tools window 1270, and/or a removed tools window 1280. In several examples, each window of user interface 1200 may include a transaction listing illustrating the raw data collected/produced by the self-inventorying tool container subject to user interface 1200.

In several examples, recent transaction window 1210 includes information pertaining to the most recent transaction recorded by the container (e.g., a timestamp, a name or label of transaction owner, and the transaction type). The recent transaction window 1210 may provide real-time updates to user interface 1210 of transactions occurring from the container subject thereto. The attributes card window 1220 may be substantially analogous to attribute card window 1126 depicted in user interface 1100, redundant explanation of which is excluded here for clarity. Attributes card window 1220 may include less or more details than attribute card window 1126.

In several examples, the inventory graph window 1230 includes a graph 1232 illustrating metrics of the inventory (i.e., trackable tools) of the container subject to user interface 1200. For example, inventory graph window 1230 may include a pie graph or circle graph illustrating the proportions of trackable tools that are currently stored in the container, outstanding from the container, added yet not assigned to the container, unassigned from the container, and/or added to the container while being assigned to a different container. Advantageously, inventory graph window 1230 provides an operator with an alternative and concise summary of the status of the container's inventory, such that the operator has a visual representation of the status of the container's trackable tools.

In several examples, the latest inventory window 1240 includes a listing of recent transactions taking place specific to the container subject to user interface 1200. Latest inventory window 1240 may include a plurality of transaction listings (i.e., transactions 1242a, 1242b, 1242c, and 1242d). Each transaction listing may include specific details pertinent to that specific transaction, which will be discussed in reference to FIGS. 8E-8F. Similarly, the outstanding tools window 1250 may also include a listing of transactions (i.e., transactions 1252a, 1252b, 1252c, 1252d, 1252e, and 1252f) taking place specific to the container subject to user interface 1200. However, the transaction listings of window 1250 may only include those transactions where a trackable tool is removed and yet to be returned to the container. Advantageously, outstanding tools window 1250 conveniently provides a user with a listing, and associated details, of all trackable tools currently out in the job site or otherwise not present in the container. Similarly, the extra tools window 1270 may also include a listing of transactions (i.e., transactions 1272a, 1272b, 1272c) taking place specific to the container subject to user interface 1200. However, the transaction listings of window 1270 may only include those transactions where tools not assigned to the container are returned to the container. Advantageously, extra tools window 1270 conveniently provides a user with a listing, and associated details, of all trackable tools currently within a container yet not assigned to it, such that an operator can keep an inventory of all trackable tools provided to a given job site (even if misplaced). Added tools window 1260 may include a listing of trackable tools, and associated details, recently assigned to the container subject to user interface 1200, while removed tools window 1280 may include a listing of trackable tools, and associated details, recently unassigned to the container subject to user interface 1200.

FIG. 8E depicts an example window 1240 of the user interface of FIG. 8D. FIG. 8F depicts an example window 1250 of the user interface of FIG. 8D. Each are discussed in turn below. Particularly, FIG. 8E and/or FIG. 8F serve to provide a detailed view of one of the windows of user interface 1200 and may be representative of other windows of user interface 1200 (i.e., recent transaction window 1210, latest inventory window 1240, outstanding tools window 1250, an added tools window 1260, extra tools window 1270, and/or a removed tools window 1280). For example, latest transaction window 1240 may include a plurality of transaction listings (e.g., transactions 1242a, 1242b, 1242c, 1242d, 1242e, 1242f, 1242g) each representing a return or withdrawal of a trackable tool from a self-inventorying tool container. Each transaction may be categorized by a plurality of data columns each including specific information pertaining to the specific transaction taken place. For example, window 1240 may include a timestamp column 1261 (indicating the time and date the transaction took place), a tool ID column 1262 (representing a code or label assigned to the trackable tool transacted), a description column 1263 (representing a description of the tool transacted), a category class column 1264 (representing a category class of the tool transacted), a make column 1265 and model column 1266 of the tool transacted, and a VDUI column 1267. As another example, as shown in FIG. 8F, outstanding tools window 1250 may include a plurality of transaction listings 1242a-1242g each representing a withdrawal of a trackable tool from a self-inventorying tool container that has yet to be returned. Each transaction of outstanding tools window 1250 may include a plurality of data columns substantially similar to that of window 1240, redundant explanation of which is excluded for clarity. However, in some examples, outstanding tools window 1250 includes a “removed by” data column 1277, such that the identity of the worker who last withdrew the trackable tool is easily identifiable.

In several examples, each window of user interface 1200 may include a plurality of navigation or action buttons. For example, window 1240 include a refresh button 1247, a search button 1246, a categorization button 1245, a export button 1244, and/or a minimize/maximize window button 1243, each operable, in turn, to refresh the listings, search for a specific transaction within the listing, change the categorization scheme of the listing, export the information within the listing, and minimize or maximize the window being viewed.

FIG. 8G depicts a user interface 1300 of an alarm notification page. In some examples, user interface 1300 is an additional or alternative dashboard to user interface 1000 and may be navigable by selection of navigation button 1302a. In several examples, user interface 1300 includes navigation buttons substantially analogous to those found in user interface 1000, including a home page button 1302a, an assets page button 1302b, a project page button 1302c, an RFID cards page button 1302d, a user's page button 1302e, and/or a reports page button 1302f, redundant explanation of which is excluded for clarity.

GUI 1300 includes an alarm window 1306 configured to provide a listing of various notifications or “alarms” to a user. In several examples, the various alarms may be configurable based on certain thresholds or parameters regarding the use of one or more self-inventorying tool containers, specific discussions of which are included with reference to FIG. 9. User interface 1300 may allow a user to view current alarms, acknowledge those alarms, and record related alarm root cause information to track conditions impacting container use. Additionally, user interface 1300 may include an important statistics window 1304 including a plurality of statistical entries illustrating important metrics associated with the use of one or more self-inventorying tool containers. For example, statistics window 1304 may include an outstanding tools entry 1308a outlining the number and percent of tools not contained within the container; a containers with outstanding tools entry 1308b outlining the number and percent of containers not including all trackable tools assigned thereto; a groups with outstanding tools entry 1308c outlining the number and percent of container groupings (i.e., the container groupings of FIG. 5B) not including all trackable tools assigned thereto; a total self-inventorying tool container count entry 1308d outlining the number of total containers managed by the user; a turnstile count entry 1308e; a projects count entry 1308f; and a groupings count entry 1308g outlining the number of different container groups managed by the user.

FIG. 9 depicts a table 1400 of example alarms of the user interface 1300. Particularly, FIG. 9 illustrates various example notifications or “alarms” that may be included in alarm window 1306. While FIG. 9 depicts several specific notifications, one skilled in the art will appreciate that FIG. 9 merely depicts several example alarms, and that the present disclosure contemplates other alarms not specifically illustrated herein that may be included in user interface 1300. For clarity, each alarm may be categorized according to its label 1402, description 1404, threshold 1406, and/or field 1408. As a non-limiting example, alarms may include an unauthorized access attempt alarm 1410a triggered by three or more consecutive invalid entry attempts (i.e., entrance of an invalid code into keypad 129). As another example, alarms may include a door left open alarm 1410b triggered by one or more doors to a container (e.g., doors 126a, 126b) being left open for five minutes or more. As another example, alarms may include a forced entry alarm 1410c triggered by one or more doors to a container (e.g., doors 126a, 126b) being opened without entrance of a code into keypad 129. As another example, alarms may include an excessive tilt alarm 1410d triggered by a container being at a certain percent angle from an upright position, suggesting that the container has been tipped over or is in danger of tipping over. As yet another example, alarms may include a manual entry alarm triggered by an entrance into a container without utilizing an entry code assigned to a specific worker, in situations where an administrator code or the like is used.

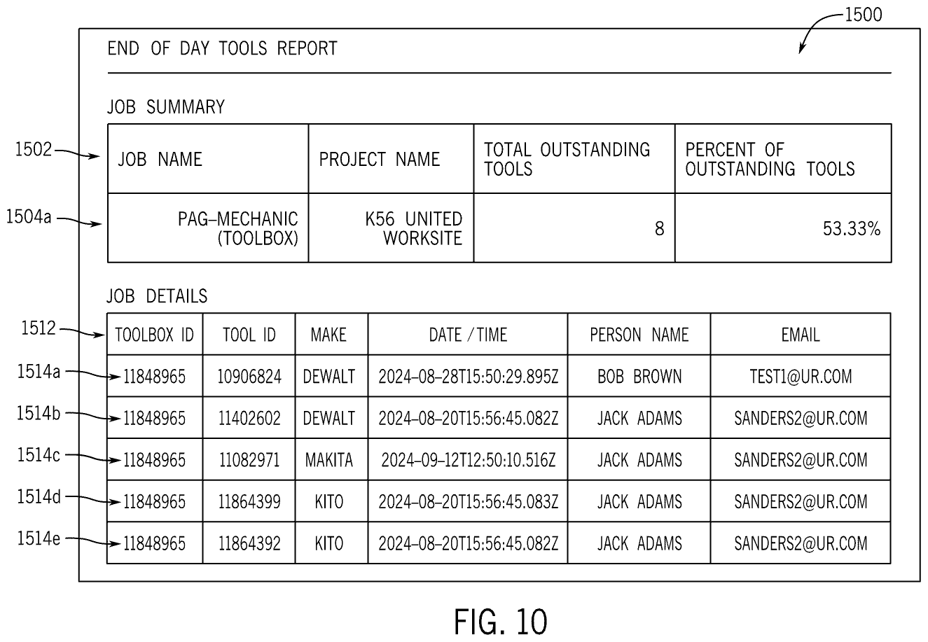

FIG. 10 depicts an example end of day report 1500. Such a report may be generated following selection of the report button 1302f of user interface 1300 or report button 1002f of user interface 100. In some examples, the end of day report 1500 may be automatically sent to an administrator and may be customizable to provide select information based on the desire. Example end of day report 1500 includes a job summary table 1502 and a job details table 1512, each optionally include one or more entries including categorical data columns. For example, job summary table 1502 may include entry 1504a referring to a particular job and outlining the total number and percentage of outstanding tools (i.e., tools not returned to the container by the end of the day). As another example job details table 1512 may include job entries 1514a-1514e each outlining specific details of a particular job assigned a self-inventorying tool container (e.g., container ID, tool ID, make, date/time, person name, email, etc.).

FIG. 11 depicts an example concert job site 1600 including an example self-inventorying tool container 1620. In many respects job site 1600 is substantially analogous to job site 100 redundant explanation of which is excluded for clarity. However, FIG. 11 illustrates the variety of use cases for the self-inventorying tool container of the present disclosure. Particularly, FIG. 11 depicts job site 1600 as a concert venue with various workers and performers 1608a-1608e utilizing radios (e.g., radios 1612a-1612b) for communication to ensure the planned event (e.g., concert) proceeds accordingly. Such radios 1612a-1612b may be the trackable tools described herein, trackable by self-inventorying tool container 1620 and storable within tool container structure 1622, functional in all other respects as described herein.

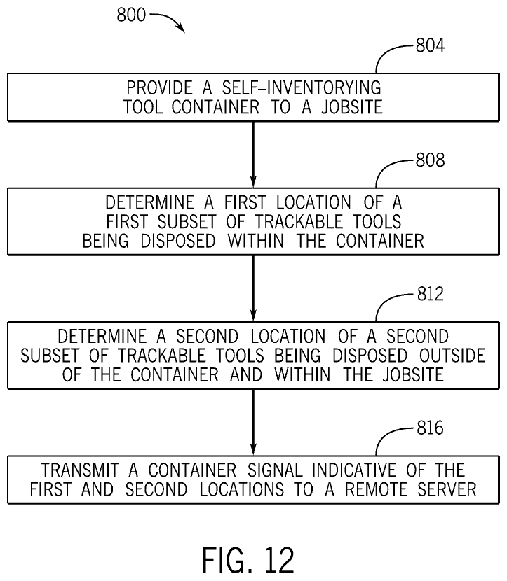

FIG. 12 depicts a flow diagram 800 of an example method for inventorying trackable construction tools on a job site is shown. At operation 804, a self-inventorying tool container is provided to a job site. For example, and with reference to FIGS. 1 and 2B, the self-inventorying tool container 120 is provided to the job site 100. The self-inventorying tool container 120 includes the trackable construction tools 136a-136e, each having associated beacons 140a-140d. At operation 808, a first location of a first subset of trackable construction tools is determined as being disposed within the container. For example, and with continued reference to FIGS. 1 and 2B, the trackable construction tools 136a-136d are determined as having a location of inside the internal tool volume 128. At operation 812, a second location of a second subset of trackable construction tools is determined as being disposed outside of the container and within the jobsite. For example, and with reference to continued reference FIGS. 1 and 2B, the trackable tool 136e is determined as having a location outside of the internal tool volume 128, such as being employed at various job tasks about the job site 100. At operation 816, a container signal indicative of the first and second locations is transmitted to a remote server. For example, and with reference to FIGS. 1, 2A, and 4, one or more processing units of the self-inventorying tool container 120 may analyze said signals from the trackable construction tools, and transmit said signals to a remove location via the antenna 156. In this regard, a remove server and associated central monitoring facility can monitor the usage and location of said trackable construction tools in substantial real-time.

FIG. 13 depicts a functional block diagram of a computer-implemented device 900 couplable with any of the self-inventorying tool containers described herein. The schematic representation in FIG. 13 is generally representative of any types of systems and configurations that may be used to receive a sensor signal in accordance with the examples described herein. For example, the device 900 may be used with or included within, or be included as part of, or used to control any of the Bluetooth gateways, scanners, beacons, transmitters, antennas, computers, user interfaces, or computer modules described herein. In this regard, the device 900 may include any appropriate hardware (e.g., computing devices, data centers, switches), software (e.g., applications, system programs, engines), network components (e.g., communication paths, interfaces, routers) and the like (not necessarily shown in the interest of clarity) for use in facilitating any appropriate operations disclosed herein.

As shown in FIG. 13, the device 900 may include a processing unit or element 901 operatively connected to computer memory 902 and computer-readable media 903. The processing unit 901 may be operatively connected to the memory 902 and computer-readable media 903 components via an electronic bus or bridge (e.g., such as system bus 907). The processing unit 901 may include one or more computer processors or microcontrollers that are configured to perform operations in response to computer-readable instructions. The processing element 901 may be a central processing unit of device 900. Additionally or alternatively, the processing unit 901 may be other processors within the device including application specific integrated chips (ASIC) and other microcontroller devices.

The memory 902 may include a variety of types of non-transitory computer-readable storage media, including, for example, read access memory (RAM), read-only memory (ROM), erasable programmable memory (e.g., EPROM and EEPROM), or flash memory. The memory 902 is configured to store computer-readable instructions, sensor values, and other persistent software elements. Computer-readable media 903 may also include a variety of types of non-transitory computer-readable storage media including, for example, a hard-drive storage device, a solid state storage device, a portable magnetic storage device, or other similar device. The computer-readable media 903 may also be configured to store computer-readable instructions, sensor values, and other persistent software elements.

The processing unit 901 may be operable to read computer-readable instructions stored on the memory 902 and/or computer-readable media 903. The computer-readable instructions may adapt the processing unit 901 to perform the operations or functions described above with respect to FIGS. 1-12. The computer-readable instructions may be provided as a computer-program product, software application, or the like.

As shown in FIG. 13, the device 900 may also include a display 904. The display 904 may include a liquid-crystal display (LCD), organic light emitting diode (OLED) display, light emitting diode (LED) display, or the like. If the display 904 is an LCD, the display may also include a backlight component that can be controlled to provide variable levels of display brightness. If the display 904 is an OLED or LED type display, the brightness of the display 904 may be controlled by modifying the electrical signals that are provided to display elements. In some examples, display 904 is operable to display the various user interfaces described herein.

The device 900 may also include a battery 905 that is configured to provide electrical power to the components of device 900. The battery 905 may include one or more power storage cells that are linked together to provide an internal supply of electrical power. In this regard, the battery 905 may be a component of a power source 905 (e.g., including a charging system or other circuitry that supplies electrical power to components of the device 900). The battery 905 may be operatively coupled to power management circuitry that is configured to provide appropriate voltage and power levels for individual components or groups of components within the device 900. The battery 905, via power management circuitry, may be configured to receive power from an external source, such as an AC power outlet or interconnected computing device. The battery 905 may store received power so that the device 900 may operate without connection to an external power source for an extended period of time, which may range from several hours to several days.

The device 900 may also include a communication port 906 that is configured to transmit and/or receive signals or electrical communication from an external or separate device. The communication port 906 may be configured to couple to an external device via a cable, adaptor, or other type of electrical connector. In some examples, the communication port 906 may be used to couple the device 900 with a computing device and/or other appropriate accessories configured to send and/or receive electrical signals. The communication port 906 may be configured to receive identifying information from an external accessory, which may be used to determine a mounting or support configuration. For example, the communication port 906 may be used to determine that the device 900 is coupled to a mounting accessory, such as a particular type of stand or support structure.

Other examples and implementations are within the scope and spirit of the disclosure and appended claims. For example, features implementing functions may also be physically located at various positions, including being distributed such that portions of functions are implemented at different physical locations. The foregoing description, for purposes of explanation, uses specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. A self-inventorying tool container for a construction job site, the self-inventorying tool container comprising
a tool container structure comprising
an enclosure defining an internal tool volume configured to receive a plurality of trackable construction tools, and
at least one a door coupled with the enclosure and operable to permit selective access to the internal tool volume and plurality of trackable construction tools held therein;
a plurality of beacons corresponding to the plurality of trackable construction tools, each beacon of the plurality of beacons configured to emit a short-range wireless signal and removable from the internal volume with the respective trackable tool;
a scanning assembly arranged with the tool container and configured to detect the short-range wireless signal of each respective beacon of the plurality of beacons relative to the internal tool volume; and
an antenna arranged with the tool container and configured to transmit a container signal indicative of a location of each trackable tool of the plurality of trackable construction tools having a corresponding beacon.

2. The tool container of claim 1, wherein the scanning assembly comprises a Bluetooth gateway and a plurality of Bluetooth Low Energy scanners associated therewith.

3. The tool container of claim 1, wherein each beacon of the plurality of beacons comprises a Bluetooth transmitter.

4. The tool container of claim 1, further comprising an access management system having
a locking mechanism securing the at least one door to the enclosure and operable to cause a release of the at least one door in response to an unlock signal, and
a keypad coupled with an exterior of the enclosure and configured to cause the locking mechanism to receive the unlock signal and release the at least one door in response to a receipt of controlled access code.

5. The tool container of claim 4, wherein the unlock signal is associated with a specific worker on the job site based on a value of the controlled access code.

6. The tool container of claim 5, further comprising a processing unit configured to associate a given beacon and corresponding trackable tool removed from the internal volume with the specific worker.

7. The tool container of claim 6, wherein given beacon and corresponding trackable tool is associated with the specific worker based in part on the scanning assembly detecting the short range wireless signal of the given beacon moving away from the tool container structure when the at least one door is unlocked for the specific user.

8. The tool container of claim 7, further comprising a door sensor configured to provide a door status signal to the processing unit indicative of the door being in an open or closed configuration.

9. The tool container of claim 8, wherein the processing unit is configured to determine a location and an orientation of the tool container structure using one or more of the antenna, an accelerometer, a gyroscope, an altimeter, or a GPS-enable component associated with the tool container structure.

10. A construction job site comprising
the self-inventorying tool container of claim 1, and
the plurality of trackable construction tools, each trackable tool of the plurality of trackable construction tools having a corresponding beacon of the plurality of beacons.

11. The construction job site of claim 10, wherein
a first subset of the plurality of trackable construction tools is disposed with the internal volume,
a second subset of the plurality of trackable construction tools is disposed across the job site, and
the container signal is indicative of a location of each trackable tool of the second subset of the plurality of trackable construction tools across the jobsite.

12. The construction job site of claim 11, wherein
a third subset of the plurality of trackable construction tools is disposed outside of the jobsite, and
the container signal is indicative of said trackable construction tools of the third subset being missing from the jobsite.

13. The construction job site of claim 11, wherein the self-inventorying tool container further includes a processing unit configured to determine a time period for which any trackable construction tools of the second subset is disposed across the jobsite and outside of the internal tool volume.

14. The construction job site of claim 13, wherein the processing unit is configured to determine a diagnostic status of the trackable tool on reentry to the internal tool volume.

15. The construction job site of claim 14, wherein the diagnostic status comprises a battery life of the trackable tool.

16. The construction job site of claim 14, wherein the processing unit is configured to analyze a utilization metric for each trackable tool of the plurality of trackable construction tools, the utilization metric indicative of a time said trackable tool is disposed outside of the internal tool volume for a given preplanned job task.

17. The construction job site of claim 10, wherein the plurality of trackable construction tools comprises power or hydraulic hand-tools, including one of a drill, an impact wrench, a saw, or welding equipment.

18. A method for inventorying trackable construction tools on a construction job site, the method comprising
providing the self-inventorying tool container of claim 1 to the job site, the self-inventorying tool container including the plurality of trackable construction tools therein, each trackable tool of the plurality of trackable construction tools associated with a corresponding beacon of the plurality of beacons;
determining, using a processing unit of the self-inventorying tool container, a first location of a first subset of trackable construction tools of the plurality of trackable construction tools based on a short-range wireless signal of each respective beacon being disposed within the internal tool volume;
determining, using the processing unit, a second location of a second subset of trackable construction tools of the plurality of trackable construction tools based on a short-range wireless signal of each respective beacon being disposed outside of the internal volume and within the job site; and
transmitting a container signal indicative of the first and second locations to a remote server.

19. The method of claim 18, further comprising selectively permitting access to the internal volume using an access management system having a locking mechanism configured to release the at least one door from covering the internal tool volume upon a verified code received at keypad of the self-inventorying tool container.

20. The method of claim 20, further comprising, using the processing unit, developing a report including a utilization metric of the trackable construction tools on the job site, the utilization metric indicative of a time said trackable tool is disposed outside of the internal tool volume for a given preplanned job task.

21. The method of claim 18, comprising
providing a plurality of the self-inventorying tool container of claim 1, and
distributing the plurality of the self-inventorying tool containers across the construction job site.

22. The method of claim 21, further comprising determining, using a mobile device associated with the plurality of the self-inventorying tool containers, a location of a selected trackable tool among the plurality of the self-inventorying tool containers.

23. The method of claim 22, wherein the method further comprises generating one or both of an audio or a visual alert at the self-inventorying tool container of the plurality of the self-inventorying tool containers associated with the selected trackable tool. 24 The method of claim 21, further comprising generating one or both of an audio or visual alert at one or more self-inventorying tool containers of the plurality of self-inventorying tool containers indicative of an evacuation request for the job site.

25. The method of claim 24, wherein the one or both of the audio or the visual alert is sequenced to indicate one or both of an evacuation route or a severity of an evacuation event.

26. The method of claim 21, further comprising generating one or both of an audio or visual alert at one or more self-inventorying tool containers of the plurality of self-inventorying tool containers in response to said self-inventorying tool container remaining open for a predefined period.

27. The method of claim 18, wherein
the self-inventorying tool container further includes a light sensor and a light source within the internal tool volume, and
the method further comprising operating the light source responsive to a level of light detected in the internal tool volume by the light sensor.

28. The method of claim 18, wherein
the self-inventorying tool container further comprises a trackable tool charging feature integrated therein, and
the method further comprises wirelessly or hard wired charging one or more trackable tools of the plurality of trackable tools.

29. The method of claim 18, wherein
the self-inventorying tool container further comprises a power pack, including one or both of a battery storage or solar capture feature, and
wherein the method further comprises powering the self-inventorying tool container using the power pack, free from AC or DC connections at the job site.

30. The method of claim 18, wherein
the self-inventorying tool container further comprises a WiFi or LoRa access point, and
the method further comprising providing access to said WiFi or LoRa access point to personnel on the job site to support job site communications.

31. The method of claim 18, wherein
the self-inventorying tool container further comprises a LoRa environmental sensor, and
the method further comprises sensing environmental conditions using said environmental sensor to support safety of the trackable tools and personnel of the job site.

32. The method of claim 18, wherein
the self-inventorying tool container further comprises an external power connection capable of support one or more of the following power inputs: 110V AC, 12-28V DC, solar, battery DC, and
the method further comprises suppling power to the self-inventorying tool container using the external power connection.
